(19) United States
(12) Patent Application Publication
(10) Pub. No.: US 2026/0322428 A1
(43) Pub. Date: Oct. 15, 2026

(54) METHOD AND DEVICE FOR PERFORMING WIRELESS COMPUTATION USING RECONFIGURABLE INTELLIGENT SURFACE IN WIRELESS COMMUNICATION SYSTEM

(71) Applicant: LG ELECTRONICS INC., Seoul (KR)

(72) Inventors: Jaeky OH, Seoul (KR); Jihwan JANG, Seoul (KR); Jaehoon CHUNG, Seoul (KR); Seungwoo RYU, Seoul (KR); Donghwan KIM, Seoul (KR)

(21) Appl. No.: 19/480,744

(22) PCT Filed: May 2, 2023
(86) PCT No.: PCT/KR2023/005936

§ 371 Date: Oct. 31, 2025

(51) Int. Cl. H04B 7/04; H04L 5/00; H04W 76/14

(52) U.S. Cl. CPC H04B 7/04026; H04L 5/0048; H04W 76/14

(57) ABSTRACT

The present disclosure relates to an operation method of a base station in a wireless communication system, and the method may comprise the steps of: transmitting a first reference signal to multiple terminals; transmitting a second reference signal to the multiple terminals on the basis of a channel between the base station and a reconfigurable intelligent surface (RIS); receiving, from the multiple terminals, channel information based on the first reference signal and the second reference signal; performing grouping into multiple groups on the basis of the channel information; transmitting, to the multiple terminals, a power control factor determined on the basis of the channel information; and receiving a signal expressing a computation result of signals that the multiple terminals have wirelessly transmitted in overlapping manner for each group, wherein the multiple groups include, with respect to the multiple terminals, a first group using a first channel for direct communication with the base station and a second group using a second channel via the RIS.

### CROSS-REFERENCE TO RELATED APPLICATIONS

This application is the National Stage filing under 35 U.S.C. 371 of International Application No. PCT/KR2023/005936 filed on May 2, 2023, which is hereby incorporated by reference herein in its entirety.

### TECHNICAL FIELD

The following description relates to a wireless communication system, and more particularly, to an apparatus and a method for performing wireless computation by using a reconfigurable intelligent surface between a base station and a user equipment (UE).

In particular, a method and an apparatus may be provided for enabling the base station and the UE to transmit and/or receive a signal by controlling a radio channel environment through a reconfigurable intelligent surface (RIS).

### BACKGROUND

Wireless communication systems have been widely deployed to provide various types of communication services including voice and data services. In general, a wireless communication system is a multiple access system that supports communication among multiple users by sharing available system resources (e.g. bandwidth, transmit power, etc.) among the multiple users. The multiple access system may adopt a multiple access scheme such as code division multiple access (CDMA), frequency division multiple access (FDMA), time division multiple access (TDMA), orthogonal frequency division multiple access (OFDMA), or single carrier frequency division multiple access (SC-FDMA).

Especially, as many communication devices have demanded large communication capacity, enhanced mobile broadband (eMBB) communication technology has been proposed compared to conventional radio access technology (RAT). In addition, communication systems that consider reliability and latency sensitive services/user equipment (UE) as well as massive machine type communications (mMTC) that connect multiple devices and objects to provide various services anytime, anywhere are being proposed. Various technical configurations have been proposed for this purpose.

The present disclosure may provide an apparatus and a method for transmitting and receiving signals in a wireless communication system.

The present disclosure may provide a method and an apparatus for transmitting and receiving signals by using a reconfigurable intelligent surface (RIS) in a wireless communication system.

The present disclosure may provide a method for performing an over-the-air computation (AirComp) technique between a base station and a UE by using an RIS in a wireless communication system.

The present disclosure may provide a method for performing grouping for AirComp by using an RIS in a wireless communication system.

The present disclosure may provide a method for performing grouping based on channel gain measured by each UE in a wireless communication system.

The present disclosure may provide a method for performing grouping based on the location of each UE in a wireless communication system.

The present disclosure may provide a method for optimizing parameters required for AirComp by using grouping in a wireless communication system.

The present disclosure may provide a method for performing federated learning between a base station and a UE (or UEs) by using AirComp with an RIS in a wireless communication system.

The present disclosure may provide a method for performing federated learning between a base station and a UE (or UEs) by using grouping in a wireless communication system.

The present disclosure also relates to an apparatus and a method for transmitting a plurality of transport blocks (TBs) as a single unit in a wireless communication system.

The technical objectives of the present disclosure are not limited to those mentioned above, and other technical problems not mentioned may be considered by one of ordinary skill in the art to which the technical configurations of the present disclosure are applied from the embodiments of the present disclosure that will be described below.

### SUMMARY

According to an embodiment of the present disclosure, a method for operating a base station in a wireless communication system, the method may comprise: transmitting, to a plurality of UEs, a first reference signal; transmitting, to the plurality of UEs, a second reference signal based on a channel between the base station and a reconfigurable intelligent surface (RIS); receiving, from the plurality of UEs, channel information based on the first reference signal and the second reference signal; performing grouping into a plurality of groups based on the channel information; transmitting, to the plurality of UEs, a power control factor determined based on the channel information; and receiving a signal in which a computation result of signals transmitted overlappingly over air by the plurality of UEs for each group is represented, wherein the plurality of groups includes a first group using a first channel for direct communication between the base station and the plurality of UEs, and a second group using a second channel through the RIS.

Furthermore, according to an embodiment of the present disclosure, A method of operating a UE in a wireless communication system, the method may comprise: receiving, from a base station, a first reference signal; receiving, from the base station, a second reference signal based on a channel between the base station and a reconfigurable intelligent surface (RIS); transmitting, to the base station, channel information based on the first and second reference signals; receiving a power control factor determined based on the channel information; determining a transmission coefficient based on the power control factor; and transmitting, to the base station, a signal based on the transmission coefficient.

Furthermore, according to an embodiment of the present disclosure, a communication device comprising: at least one processor; at least one computer memory connected to the at least one processor and storing instructions that, based on being executed by the at least one processor, cause the device to perform operations, wherein the operations may comprise: transmitting, to a plurality of UEs, a first reference signal; transmitting, to the plurality of UEs, a second reference signal based on a channel between the base station and a reconfigurable intelligent surface (RIS); receiving, from the plurality of UEs, channel information based on the first reference signal and the second reference signal; performing grouping into a plurality of groups based on the channel information; transmitting, to the plurality of UEs, a power control factor determined based on the channel information; and receiving a signal in which a computation result of signals transmitted overlappingly over air by the plurality of UEs for each group is represented, wherein the plurality of groups includes a first group using a first channel for direct communication between the base station and the plurality of UEs, and a second group using a second channel through the RIS.

Furthermore, according to an embodiment of the present disclosure, a communication device comprising: at least one processor; at least one computer memory connected to the at least one processor and storing instructions that, based on being executed by the at least one processor, cause the device to perform operations, wherein the operations may comprise: receiving, from a base station, a first reference signal; receiving, from the base station, a second reference signal based on a channel between the base station and a reconfigurable intelligent surface (RIS); transmitting, to the base station, channel information based on the first and second reference signals; receiving a power control factor determined based on the channel information; determining a transmission coefficient based on the power control factor; and transmitting, to the base station, a signal based on the transmission coefficient.

Furthermore, according to an embodiment of the present disclosure, a non-transitory computer-readable medium storing at least one instruction, comprising the at least one instruction being executable by a processor, wherein the at least one instruction is configured to perform operations may comprise: transmitting, to a plurality of UEs, a first reference signal; transmitting, to the plurality of UEs, a second reference signal based on a channel between the base station and a reconfigurable intelligent surface (RIS); receiving, from the plurality of UEs, channel information based on the first reference signal and the second reference signal; performing grouping into a plurality of groups based on the channel information; transmitting, to the plurality of UEs, a power control factor determined based on the channel information; and receiving a signal in which a computation result of signals transmitted overlappingly over air by the plurality of UEs for each group is represented, wherein the plurality of groups includes a first group using a first channel for direct communication between the base station and the plurality of UEs, and a second group using a second channel through the RIS.

In addition, the following may be commonly applied.

According to an embodiment of the present disclosure, wherein transmitting, to the plurality of UEs, the first reference signal, may comprise: transmitting, to the RIS, a stop signal.

Furthermore, according to an embodiment of the present disclosure, wherein transmitting, to the plurality of UEs, the second reference signal based on a channel between the base station and the RIS,

May comprise: determining a beamforming coefficient and a reflection pattern of the RIS based on measured channel between the base station and the RIS; transmitting, to the RIS, the reflection pattern; and transmitting, to the plurality of UEs, the second reference signal based on the beamforming coefficient.

Furthermore, according to an embodiment of the present disclosure, wherein the channel information may include channel identification information having a largest channel gain and a channel gain value, and wherein the grouping may be performed with UEs for which the channel identification information having a largest channel gain is same.

Furthermore, according to an embodiment of the present disclosure, wherein the plurality of groups may further include a group in which UEs having the channel gain value not exceeding a threshold do not transmit signal to the base station.

Furthermore, according to an embodiment of the present disclosure, may further comprise: adding a compensation margin to the channel gain based on at least one of a number of antennas of the base station, a number of elements of the RIS, a power of the first reference signal, a power of the second reference signal or a beam gain of the RIS beam sweeping.

Furthermore, according to an embodiment of the present disclosure, wherein transmitting, to the plurality of UEs, the power control factor determined based on the channel information, may comprise: determining a beamforming vector of the second group based on measured channel environment between the base station and the RIS of the second group; determining a decoding vector for the second group based on the beamforming vector of the second group; optimizing a RIS reflection pattern for communication of the second group based on the decoding vector of the second group; and determining a power control factor for the second group based on the decoding vector and the RIS reflection pattern which is optimized.

Furthermore, according to an embodiment of the present disclosure, wherein receiving the signal in which the computation result of signals transmitted overlappingly over air by the plurality of UEs for each group is represented, may comprise: transmitting, to the plurality of UEs, a start signal of the first group; receiving, from a UE of the first group, a signal based on a control factor of the first group; transmitting, to the plurality of UEs, a start signal of the second group; and receiving, from a UE of the second group, a signal based on a power control factor of the second group.

Furthermore, according to an embodiment of the present disclosure, may further comprise: transmitting, to the plurality of UEs, a property value of a global model for federated learning; and learning the global model based on the signal in which a computation result of signals transmitted overlappingly over air by the plurality of UEs for each group is represented.

Furthermore, according to an embodiment of the present disclosure, wherein the learning the global model based on the signal in which a computation result of signals transmitted overlappingly over air by the plurality of UEs for each group is represented, may comprise: determining a local model for the each group based on the overlapping signals of the each group; and learning the global model based on the local model of the each group.

The above-described features of the present disclosure are only some of the preferred embodiments of the present disclosure, and various embodiments reflecting the technical features of the present disclosure may be derived and understood by one with ordinary skill in the art based on the detailed description of the present disclosure that follows.

According to embodiments based on the present disclosure, the following effects may be achieved.

According to embodiments based on the present disclosure, a UE and a base station may transmit and receive signals by using a reconfigurable intelligent surface (RIS).

According to embodiments based on the present disclosure, a UE and a base station may perform over-the-air computation (AirComp) technique using an RIS.

According to embodiments based on the present disclosure, a base station and UEs may perform grouping for AirComp using an RIS.

According to embodiments based on the present disclosure, a base station may perform grouping based on the channel gains measured by each UE.

According to embodiments based on the present disclosure, a base station may perform grouping based on the location of each UE.

According to embodiments based on the present disclosure, UEs may optimize parameters necessary for AirComp.

According to embodiments based on the present disclosure, a method may be provided in which a UE and a base station perform federated learning using AirComp with an RIS.

According to the present disclosure, a base station and UEs may perform federated learning using grouping in a wireless communication system.

It will be appreciated by persons skilled in the art that the effects that may be achieved with the present disclosure are not limited to what has been particularly described hereinabove and other advantages of the present disclosure will be more clearly understood from the following detailed description taken in conjunction with the accompanying drawings. That is, unintended effects of the present disclosure may be also derived by those skilled in the art from the embodiments of the present disclosure.

### BRIEF DESCRIPTION OF THE DRAWINGS

The accompanying drawings are intended to provide a better understanding of the present disclosure and may provide embodiments of the disclosure along with a detailed description. However, the technical features of the present disclosure are not limited to any specific drawing, and the features disclosed in each drawing may be combined with each other to form new embodiments. Reference numerals in each drawing may refer to structural elements.

FIG. 1 shows an example communication system applicable to the present disclosure.

FIG. 2 shows an example of a wireless device applicable to the present disclosure.

FIG. 3 shows another example of a wireless device applicable to the present disclosure.

FIG. 4 shows an example of a mobile device applicable to the present disclosure.

FIG. 5 shows an example of a vehicle or autonomous vehicle applicable to the present disclosure.

FIG. 6 shows an example of artificial intelligence (AI) applicable to the present disclosure.

FIG. 7 shows a method of processing a transmission signal applicable to the present disclosure.

FIG. 8 shows an example of a communication structure that can be provided in a 6th generation (6G) system applicable to the present disclosure.

FIG. 9 shows an electromagnetic spectrum applicable to the present disclosure.

FIG. 10 shows a THz communication method applicable to the present disclosure.

FIG. 11 is a diagram illustrating a radio channel environment according to an embodiment of the present disclosure.

FIG. 12 is a diagram illustrating a smart radio environment according to an embodiment of the present disclosure.

FIGS. 13a and 13b are diagrams illustrating a conventional radio channel environment and a smart radio channel environment according to an embodiment of the present disclosure.

FIG. 14 is a diagram illustrating a method for performing optimization in a smart radio channel environment according to an embodiment of the present disclosure.

FIG. 15 is a diagram illustrating a Trust Region according to an embodiment of the present disclosure.

FIG. 16 is a diagram illustrating the structure of a federated learning system using AirComp technique according to an embodiment of the present disclosure.

FIG. 17 is a diagram illustrating an AirComp system using an RIS and the channel information according to an embodiment of the present disclosure.

FIG. 18 is a diagram illustrating a transmitter and receiver structure of the UE and the base station for an AirComp system according to an embodiment of the present disclosure.

FIG. 19 is a diagram illustrating an operation method of a base station in an AirComp system using an RIS according to an embodiment of the present disclosure.

FIG. 20 is a diagram illustrating an operation method of a UE participating in an AirComp system using RIS according to an embodiment of the present disclosure.

FIG. 21 is a diagram illustrating a signal flow between the base station, RIS and UEs in an AirComp system using RIS according to an embodiment of the present disclosure.

FIG. 22 is a diagram illustrating an AirComp system environment using a RIS according to an embodiment of the present disclosure.

FIG. 23 is a diagram illustrating a method of performing grouping for UEs that will utilize AirComp technique using an RIS, according to an embodiment of the present disclosure.

FIG. 24 is a diagram illustrating an operation method of a base station that performs grouping based on channel gain using an RIS according to an embodiment of the present disclosure.

FIG. 25 is a diagram illustrating a signal flow among a base station, UE and an RIS when grouping is performed using the RIS according to an embodiment of the present disclosure.

FIG. 26 is a diagram illustrating a method in which a base station performs AirComp communication through grouping for device selection according to an embodiment of the present disclosure.

FIG. 27 is a diagram illustrating a signal flow between a base station, an RIS and each UE group in an environment for performing AirComp communication using an RIS, according to an embodiment of the present disclosure.

FIG. 28 is diagram illustrating a signal flow between a base station, an RIS and k groups in a federated learning system environment utilizing AirComp communication using the RIS according to an embodiment of the present disclosure.

### DETAILED DESCRIPTION

The embodiments of the present disclosure described hereinbelow are combinations of elements and features of the present disclosure. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or features of any one embodiment may be included in another embodiment and may be replaced with corresponding constructions or features of another embodiment.

In the description of the attached drawings, a detailed description of known procedures or steps of the present disclosure will be avoided lest it should obscure the subject matter of the present disclosure. In addition, procedures or steps that could be understood to those skilled in the art will not be described either.

Throughout the specification, whenever any part is the to “comprising or including” any component, it is meant to be inclusive of other components, not exclusive of other components, unless specifically stated to the contrary. In addition, terms such as “ . . . part,” “ . . . device,” “module,” and the like in the specification mean a unit that performs at least one function or operation, which may be implemented in hardware or software or a combination of hardware and software. In addition, the terms “a or an,” “one,” “the,” and similar related words may be used in the context of describing this disclosure (especially in the context of the following claims) to include both the singular and the plural, unless otherwise indicated herein or clearly refuted by the context.

In the embodiments of the present disclosure, a description is made, centering on a data transmission and reception relationship between a Base Station (BS) and a User Equipment (UE). A BS is a terminal node of a network, which communicates directly with a UE. In some cases, a specific operation described as performed by the BS may be performed by an upper node of the BS.

Namely, it is apparent that, in a network comprised of a plurality of network nodes including a BS, various operations performed for communication with a UE may be performed by the BS or network nodes other than the BS. The term ‘BS' may be replaced with the term ‘fixed station’, ‘Node B’, ‘evolved Node B (eNode B or eNB)’, Advanced BS (ABS)’, ‘Access Point (AP)’, etc.

In addition, the term ‘terminal’ may be replaced with the term ‘UE’, ‘Mobile Station (MS)’, ‘Subscriber Station (SS)’, ‘Mobile Subscriber Station (MSS)’, ‘Mobile Terminal’, ‘Advanced MS (AMS)’, etc.

A transmission end refers to a fixed and/or mobile node that provides data service or voice service and a reception end refers to a fixed and/or mobile node that receives data service or voice service. Accordingly, a UE may serve as a transmission end and a BS may serve as a reception end, on the uplink, whereas the UE may serve as a reception end and the BS may serve as a transmission end, on the downlink.

The embodiments of the present disclosure may be supported by standard documents disclosed for at least one of wireless access systems, that is, an Institute of Electrical and Electronics Engineers (IEEE) 802.xx system, a 3rd Generation Partnership Project (3GPP) system, a 3GPP Long Term Evolution (LTE) system, and a 3GPP2 system. Especially, the embodiments of the present disclosure may be supported by 3GPP TS 38.211, 3GPP TS 38.212, 3GPP TS 38.213, and 3GPP TS 38.321.

Further, embodiments of the present disclosure may be applicable to other wireless access systems and are not limited to the systems described above. For example, they may be applicable to post-3GPP 5G NR systems, and are not limited to any specific system.

That is, steps or parts that are not described in order to clarify the subject matter of the present disclosure may be supported by the above documents. Further, all terms described in this specification may be explained by the standard documents.

Reference will now be made in detail to the preferred embodiments of the present disclosure with reference to the accompanying drawings. The detailed description, which will be given below with reference to the accompanying drawings, is intended to explain exemplary embodiments of the present disclosure, rather than to show the only embodiments that may be implemented according to the disclosure.

Specific terms used in the embodiments of the present disclosure are used to help the understanding of the present disclosure and they may be replaced with other terms within the spirit and scope of the present disclosure.

The following embodiments of the present disclosure may be applied to a variety of wireless access technologies, for example, CDMA, FDMA, TDMA, OFDMA, SC-FDMA, MC-FDMA, and the like.

For clarity, the following description is based on 3GPP communication systems (e.g., LTE, NR, etc.), but the technical ideas of the present disclosure are not limited thereto. LTE may refer to technology from 3GPP TS 36.xxx Release 8 onwards. More specifically, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology from TS Release 17 and/or Release 18 onwards. “xxx” means standard document detail number. LTE/NR/6G may be referred to collectively as the 3GPP system.

For background descriptions, terms, abbreviations, and the like used in this disclosure, reference is made to standards documents published prior to this disclosure. For example, the 36.xxx and 38.xxx standards documents may be referenced.

### Communication System Applicable to the Present Disclosure

The various descriptions, functions, procedures, proposals, methods, and/or operational flowcharts of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

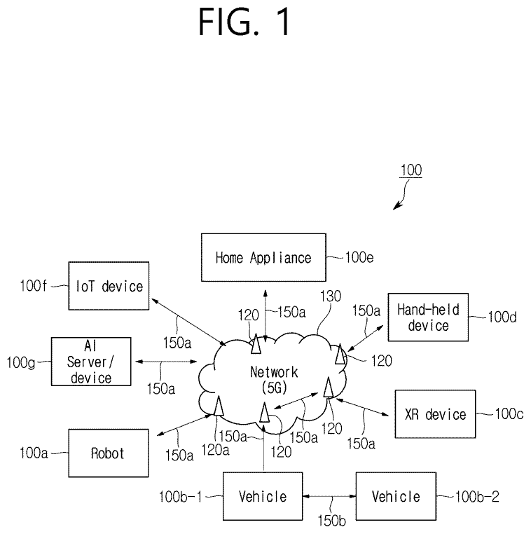

FIG. 1 shows a communication system applied to the present disclosure.

Referring to FIG. 1, a communication system 100 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 100g. For example, the vehicles 100b-1, 100b-2 may include a vehicle having a wireless communication function, an autonomous vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device 100d may include a smartphone, a smartpad, a wearable device (e.g., a smartwatch or a smartglasses), and a computer (e.g., a notebook). The home appliance 100e may include a TV, a refrigerator, and a washing machine. The IoT device 100f may include a sensor and a smartmeter. For example, the BSs 120 and the network 130 may be implemented as wireless devices and a specific wireless device 120a may operate as a BS/network node with respect to other wireless devices.

The wireless devices 100a to 100f may be connected to the network 120 via the BSs 120. An AI technology may be applied to the wireless devices 100a to 100f and the wireless devices 100a to 100f may be connected to the AI server 100g via the network 130. The network 130 may be configured using a 3G network, a 4G (e.g., LTE) network, or a 5G (e.g., NR) network. Although the wireless devices 100a to 100f may communicate with each other through the BSs 120/network 130, the wireless devices 100a to 100f may perform direct communication (e.g., sidelink communication) with each other without passing through the BSs 120/network 130. For example, the vehicles 100b-1 and 100b-2 may perform direct communication (e.g. Vehicle-to-Vehicle (V2V)/Vehicle-to-everything (V2X) communication). The IoT device 100f (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 120, or BS 120/BS 120. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (JAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

### Communication System Applicable to the Present Disclosure

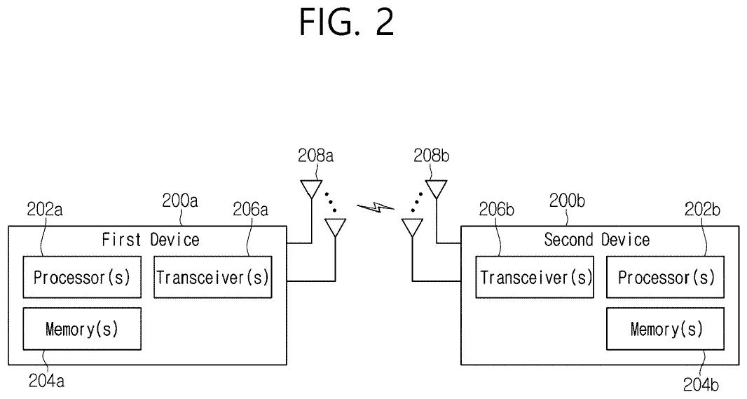

FIG. 2 is a diagram showing an example wireless device that may be applicable to the present disclosure.

Referring to FIG. 2, a first wireless device 200a and a second wireless device 200b may transmit radio signals through a variety of RATs (e.g., LTE and NR). Herein, {the first wireless device 200a and the second wireless device 200b} may correspond to {the wireless device 100x and the BS 120} and/or {the wireless device 100x and the wireless device 100x} of FIG. 1.

The first wireless device 200a may include one or more processors 202a and one or more memories 204a and additionally further include one or more transceivers 206a and/or one or more antennas 208a. The processor(s) 202a may control the memory(s) 204a and/or the transceiver(s) 206a and may be configured to implement the descriptions, functions, procedures, proposals, methods, and/or operational flowcharts disclosed in this document. For example, the processor(s) 202a may process information within the memory(s) 204a to generate first information/signals and then transmit radio signals including the first information/signals through the transceiver(s) 206a. The processor(s) 202a may receive radio signals including second information/signals through the transceiver 206a and then store information obtained by processing the second information/signals in the memory(s) 204a. The memory(s) 204a may be connected to the processor(s) 202a and may store a variety of information related to operations of the processor(s) 202a. For example, the memory(s) 204a may store software code including commands for performing a part or the entirety of processes controlled by the processor(s) 202a or for performing the descriptions, functions, procedures, proposals, methods, and/or operational flowcharts disclosed in this document. Herein, the processor(s) 202a and the memory(s) 204a may be a part of a communication modem/circuit/chip designed to implement RAT (e.g., LTE or NR). The transceiver(s) 206a may be connected to the processor(s) 202a and transmit and/or receive radio signals through one or more antennas 208a. Each of the transceiver(s) 206a may include a transmitter and/or a receiver. The transceiver(s) 206a may be interchangeably used with Radio Frequency (RF) unit(s). In the present disclosure, the wireless device may represent a communication modem/circuit/chip.

The second wireless device 200b may include one or more processors 202b and one or more memories 204b and additionally further include one or more transceivers 206b and/or one or more antennas 208b. The processor(s) 202b may control the memory(s) 204b and/or the transceiver(s) 206b and may be configured to implement the descriptions, functions, procedures, proposals, methods, and/or operational flowcharts disclosed in this document. For example, the processor(s) 202b may process information within the memory(s) 204b to generate third information/signals and then transmit radio signals including the third information/signals through the transceiver(s) 206b. The processor(s) 202b may receive radio signals including fourth information/signals through the transceiver(s) 206b and then store information obtained by processing the fourth information/signals in the memory(s) 204b. The memory(s) 204b may be connected to the processor(s) 202b and may store a variety of information related to operations of the processor(s) 202b. For example, the memory(s) 204b may store software code including commands for performing a part or the entirety of processes controlled by the processor(s) 202b or for performing the descriptions, functions, procedures, proposals, methods, and/or operational flowcharts disclosed in this document. Herein, the processor(s) 202b and the memory(s) 204b may be a part of a communication modem/circuit/chip designed to implement RAT (e.g., LTE or NR). The transceiver(s) 206b may be connected to the processor(s) 202b and transmit and/or receive radio signals through one or more antennas 208b. Each of the transceiver(s) 206b may include a transmitter and/or a receiver. The transceiver(s) 206b may be interchangeably used with RF unit(s). In the present disclosure, the wireless device may represent a communication modem/circuit/chip.

Hereinafter, hardware elements of the wireless devices 200a and 200b will be described more specifically. One or more protocol layers may be implemented by, without being limited to, one or more processors 202a and 202b. For example, the one or more processors 202a and 202b may implement one or more layers (e.g., functional layers such as PHY, MAC, RLC, PDCP, RRC, and SDAP). The one or more processors 202a and 202b may generate one or more Protocol Data Units (PDUs) and/or one or more Service Data Unit (SDUs) according to the descriptions, functions, procedures, proposals, methods, and/or operational flowcharts disclosed in this document. The one or more processors 202a and 202b may generate messages, control information, data, or information according to the descriptions, functions, procedures, proposals, methods, and/or operational flowcharts disclosed in this document. The one or more processors 202a and 202b may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 206a and 206b. The one or more processors 202a and 202b may receive the signals (e.g., baseband signals) from the one or more transceivers 206a and 206b and acquire the PDUs, SDUs, messages, control information, data, or information according to the descriptions, functions, procedures, proposals, methods, and/or operational flowcharts disclosed in this document.

The one or more processors 202a and 202b may be referred to as controllers, microcontrollers, microprocessors, or microcomputers. The one or more processors 202a and 202b may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 202a and 202b. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 202a and 202b or stored in the one or more memories 204a and 204b so as to be driven by the one or more processors 202a and 202b. The descriptions, functions, procedures, proposals, methods, and/or operational flowcharts disclosed in this document may be implemented using firmware or software in the form of code, commands, and/or a set of commands.

The one or more memories 204a and 204b may be connected to the one or more processors 202a and 202b and store various types of data, signals, messages, information, programs, code, instructions, and/or commands. The one or more memories 204a and 204b may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 204a and 204b may be located at the interior and/or exterior of the one or more processors 202a and 202b. The one or more memories 204a and 204b may be connected to the one or more processors 202a and 202b through various technologies such as wired or wireless connection.

The one or more transceivers 206a and 206b may transmit user data, control information, and/or radio signals/channels, mentioned in the methods and/or operational flowcharts of this document, to one or more other devices. The one or more transceivers 206a and 206b may receive user data, control information, and/or radio signals/channels, mentioned in the descriptions, functions, procedures, proposals, methods, and/or operational flowcharts disclosed in this document, from one or more other devices. For example, the one or more transceivers 206a and 206b may be connected to the one or more processors 202a and 202b and transmit and receive radio signals. For example, the one or more processors 202a and 202b may perform control so that the one or more transceivers 206a and 206b may transmit user data, control information, or radio signals to one or more other devices. The one or more processors 202a and 202b may perform control so that the one or more transceivers 206a and 206b may receive user data, control information, or radio signals from one or more other devices. The one or more transceivers 206a and 206b may be connected to the one or more antennas 208a and 208b and the one or more transceivers 206a and 206b may be configured to transmit and receive user data, control information, and/or radio signals/channels, mentioned in the descriptions, functions, procedures, proposals, methods, and/or operational flowcharts disclosed in this document, through the one or more antennas 208a and 208b. In this document, the one or more antennas may be a plurality of physical antennas or a plurality of logical antennas (e.g., antenna ports). The one or more transceivers 206a and 206b may convert received radio signals/channels etc. from RF band signals into baseband signals in order to process received user data, control information, radio signals/channels, etc. using the one or more processors 202a and 202b. The one or more transceivers 206a and 206b may convert the user data, control information, radio signals/channels, etc. processed using the one or more processors 202a and 202b from the base band signals into the RF band signals. To this end, the one or more transceivers 206a and 206b may include (analog) oscillators and/or filters.

### Structure of Wireless Device Applicable to the Present Disclosure

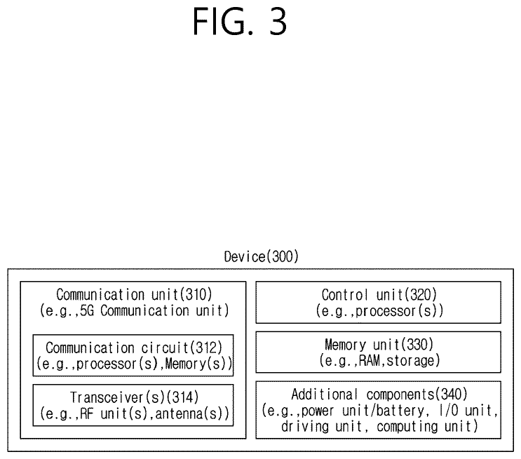

FIG. 3 is a view showing another example of a wireless device applicable to the present disclosure.

Referring to FIG. 3, a wireless device 300 may correspond to the wireless devices 200 a and 200 b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202 a and 202 b and/or one or more memories 204 a and 204 b of FIG. 2. For example, the transceiver(s) 314 may include one or more transceivers 206 a and 206 b and/or one or more antennas 208 a and 208 b of FIG. 2. The control unit 320 may be electrically connected with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100 a), the vehicles (FIG. 1, 100 b-1 and 100 b-2), the XR device (FIG. 1, 100 c), the hand-held device (FIG. 1, 100 d), the home appliance (FIG. 1, 100 e), the IoT device (FIG. 1, 100 f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be connected with each other through wired interfaces or at least some thereof may be wirelessly connected through the communication unit 310. For example, in the wireless device 300, the control unit 320 and the communication unit 310 may be connected by wire, and the control unit 320 and the first unit (e.g., 130 or 140) may be wirelessly connected through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

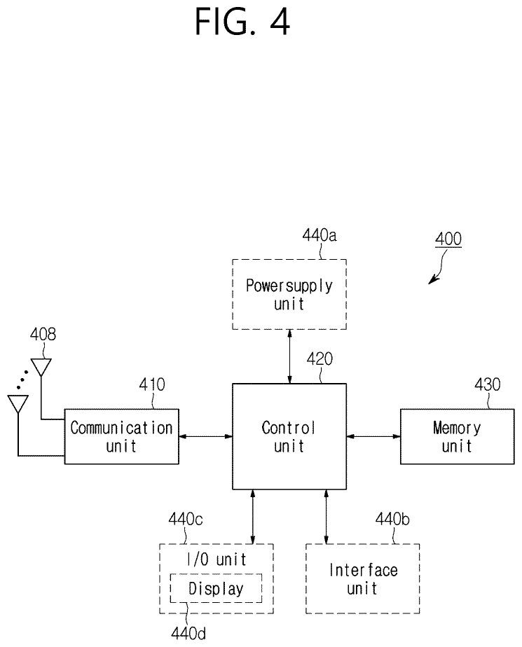

FIG. 4 is a view showing an example of a hand-held device applicable to the present disclosure.

FIG. 4 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 4, the hand-held device 400 may include an antenna unit (antenna) 408, a communication unit (transceiver) 410, a control unit (controller) 420, a memory unit (memory) 430, a power supply unit (power supply) 440 a, an interface unit (interface) 440 b, and an input/output unit 440 c. An antenna unit (antenna) 408 may be part of the communication unit 410. The blocks 410 to 430/440 a to 440 c may correspond to the blocks 310 to 330/340 of FIG. 3, respectively.

The communication unit 410 may transmit and receive signals (e.g., data, control signals, etc.) to and from other wireless devices or base stations. The control unit 420 may control the components of the hand-held device 400 to perform various operations. The control unit 420 may include an application processor (AP). The memory unit 430 may store data/parameters/program/code/instructions necessary to drive the hand-held device 400. In addition, the memory unit 430 may store input/output data/information, etc. The power supply unit 440 a may supply power to the hand-held device 400 and include a wired/wireless charging circuit, a battery, etc. The interface unit 440 b may support connection between the hand-held device 400 and another external device. The interface unit 440 b may include various ports (e.g., an audio input/output port and a video input/output port) for connection with the external device. The input/output unit 440 c may receive or output video information/signals, audio information/signals, data and/or user input information. The input/output unit 440 c may include a camera, a microphone, a user input unit, a display 440 d, a speaker and/or a haptic module.

For example, in case of data communication, the input/output unit 440 c may acquire user input information/signal (e.g., touch, text, voice, image or video) from the user and store the user input information/signal in the memory unit 430. The communication unit 410 may convert the information/signal stored in the memory into a radio signal and transmit the converted radio signal to another wireless device directly or transmit the converted radio signal to a base station. In addition, the communication unit 410 may receive a radio signal from another wireless device or the base station and then restore the received radio signal into original information/signal. The restored information/signal may be stored in the memory unit 430 and then output through the input/output unit 440 c in various forms (e.g., text, voice, image, video and haptic).

### Type of Wireless Device Applicable to the Present Disclosure

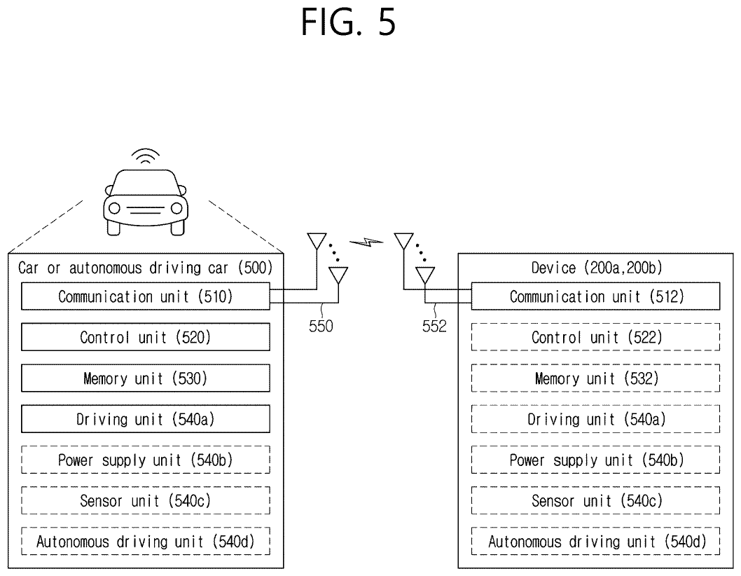

FIG. 5 is a view showing an example of a car or an autonomous driving car applicable to the present disclosure.

FIG. 5 shows a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited.

Referring to FIG. 5, the car or autonomous driving car 500 may include an antenna unit (antenna) 508, a communication unit (transceiver) 510, a control unit (controller) 520, a driving unit 540 a, a power supply unit (power supply) 540 b, a sensor unit 540 c, and an autonomous driving unit 540 d. The antenna unit 550 may be configured as part of the communication unit 510. The blocks 510/530/540 a to 540 d correspond to the blocks 410/430/440 of FIG. 4.

The communication unit 510 may transmit and receive signals (e.g., data, control signals, etc.) to and from external devices such as another vehicle, a base station (e.g., a base station, a road side unit, etc.), and a server. The control unit 520 may control the elements of the car or autonomous driving car 500 to perform various operations. The control unit 520 may include an electronic control unit (ECU).

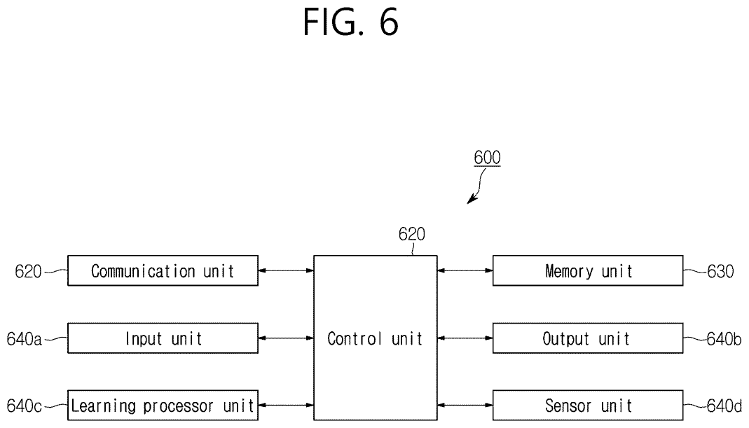

FIG. 6 is a view showing an example of artificial intelligence (AI) device applicable to the present disclosure. For example, the AI device may be implemented as fixed or movable devices such as a TV, a projector, a smartphone, a PC, a laptop, a digital broadcast terminal, a tablet PC, a wearable device, a set-top box (STB), a radio, a washing machine, a refrigerator, a digital signage, a robot, a vehicle, or the like.

Referring to FIG. 6, the AI device 600 may include a communication unit (transceiver) 610, a control unit (controller) 620, a memory unit (memory) 630, an input/output unit 640 a/640 b, a leaning processor unit (learning processor) 640 c and a sensor unit 640 d. The blocks 610 to 630/640 a to 640 d may correspond to the blocks 310 to 330/340 of FIG. 3, respectively.

The communication unit 610 may transmit and receive wired/wireless signals (e.g., sensor information, user input, learning models, control signals, etc.) to and from external devices such as another AI device (e.g., FIG. 1, 100 x, 120 or 140) or the AI server (FIG. 1, 140) using wired/wireless communication technology. To this end, the communication unit 610 may transmit information in the memory unit 630 to an external device or transfer a signal received from the external device to the memory unit 630.

The control unit 620 may determine at least one executable operation of the AI device 600 based on information determined or generated using a data analysis algorithm or a machine learning algorithm. In addition, the control unit 620 may control the components of the AI device 600 to perform the determined operation. For example, the control unit 620 may request, search for, receive or utilize the data of the learning processor unit 640 c or the memory unit 630, and control the components of the AI device 600 to perform predicted operation or operation, which is determined to be desirable, of at least one executable operation. In addition, the control unit 620 may collect history information including operation of the AI device 600 or user's feedback on the operation and store the history information in the memory unit 630 or the learning processor unit 640 c or transmit the history information to the AI server (FIG. 1, 140). The collected history information may be used to update a learning model.

The memory unit 630 may store data supporting various functions of the AI device 600. For example, the memory unit 630 may store data obtained from the input unit 640 a, data obtained from the communication unit 610, output data of the learning processor unit 640 c, and data obtained from the sensing unit 640. In addition, the memory unit 630 may store control information and/or software code necessary to operate/execute the control unit 620.

The input unit 640 a may acquire various types of data from the outside of the AI device 600. For example, the input unit 640 a may acquire learning data for model learning, input data, to which the learning model will be applied, etc. The input unit 640 a may include a camera, a microphone and/or a user input unit. The output unit 640 b may generate video, audio or tactile output. The output unit 640 b may include a display, a speaker and/or a haptic module. The sensing unit 640 may obtain at least one of internal information of the AI device 600, the surrounding environment information of the AI device 600 and user information using various sensors. The sensing unit 640 may include a proximity sensor, an illumination sensor, an acceleration sensor, a magnetic sensor, a gyro sensor, an inertia sensor, a red green blue (RGB) sensor, an infrared (IR) sensor, a finger scan sensor, an ultrasonic sensor, an optical sensor, a microphone and/or a radar.

The learning processor unit 640 c may train a model composed of an artificial neural network using training data. The learning processor unit 640 c may perform AI processing along with the learning processor unit of the AI server (FIG. 1, 140). The learning processor unit 640 c may process information received from an external device through the communication unit 610 and/or information stored in the memory unit 630. In addition, the output value of the learning processor unit 640 c may be transmitted to the external device through the communication unit 610 and/or stored in the memory unit 630.

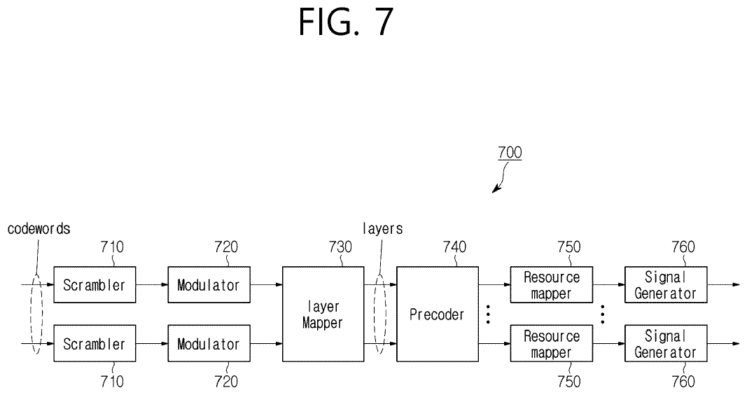

FIG. 7 shows a signal process circuit for a transmission signal, based on an embodiment of the present disclosure. For example, a signal processing circuit 700 may include scramblers 710, modulators 720, a layer mapper 730, a precoder 740, resource mappers 750, and signal generators 760. Here, for example, an operation/function of FIG. 2 may be performed, in the processors 202a and 202b and/or the transceivers 206a and 206b of FIG. 7. Hardware elements of FIG. 7 may be implemented by the processors 202a and 202b and/or the transceivers 206a and 206b of FIG. 7. For example, blocks 710 to 760 may be implemented by the processors 202a and 202b of FIG. 7. Alternatively, the blocks 710 to 750 may be implemented by the processors 202a and 202b of FIG. 7 and the block 760 may be implemented by the transceivers 206a and 206b of FIG. 7, and not limited to the above embodiment.

Codewords may be converted into radio signals via the signal processing circuit 700 of FIG. 7. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH). Specifically, the codewords may be converted into scrambled bit sequences by the scramblers 710. Scramble sequences used for scrambling may be generated based on an initialization value, and the initialization value may include ID information of a wireless device. The scrambled bit sequences may be modulated to modulation symbol sequences by the modulators 720. A modulation scheme may include pi/2-Binary Phase Shift Keying (pi/2-BPSK), m-Phase Shift Keying (m-PSK), and m-Quadrature Amplitude Modulation (m-QAM).

Complex modulation symbol sequences may be mapped to one or more transport layers by the layer mapper 730. Modulation symbols of each transport layer may be mapped (precoded) to corresponding antenna port(s) by the precoder 740. Outputs z of the precoder 740 may be obtained by multiplying outputs y of the layer mapper 730 by an N*M precoding matrix W. Herein, N is the number of antenna ports and M is the number of transport layers. The precoder 740 may perform precoding after performing transform precoding (e.g., DFT) for complex modulation symbols. Alternatively, the precoder 740 may perform precoding without performing transform precoding.

The resource mappers 750 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 760 may generate radio signals from the mapped modulation symbols and the generated radio signals may be transmitted to other devices through each antenna. For this purpose, the signal generators 760 may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures 710 to 760 of FIG. 7. For example, the wireless devices (e.g., 200a and 200b of FIG. 2) may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

### 6G Communication System

The 6G (wireless communication) system aims at (i) very high data rates per device, (ii) a very large number of connected devices, (iii) global connectivity, (iv) very low latency, (v) lower energy consumption of battery-free IoT devices, (vi) ultra-reliable connectivity, and (vii) connected intelligence with machine learning capabilities. The vision of the 6G system may be divided into four aspects: “intelligent connectivity”, “deep connectivity”, “holographic connectivity”, and “ubiquitous connectivity”, and the 6G system may satisfy the requirements as shown in Table 1 below. That is, Table 1 is a table showing the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | up to 1000 km/hr |
| Satellite integration | Fully |
| AI | Fully |
| Autonomous vehicle | Fully |
| XR | Fully |
| Haptic Communication | Fully |

At this time, 6G systems may have key factors such as enhanced mobile broadband (eMBB), ultra-reliable low latency communications (URLLC), massive machine type communications (mMTC), AI integrated communication, tactile internet, high throughput, high network capacity, high energy efficiency, low backhaul and access network congestion, and enhanced data security.

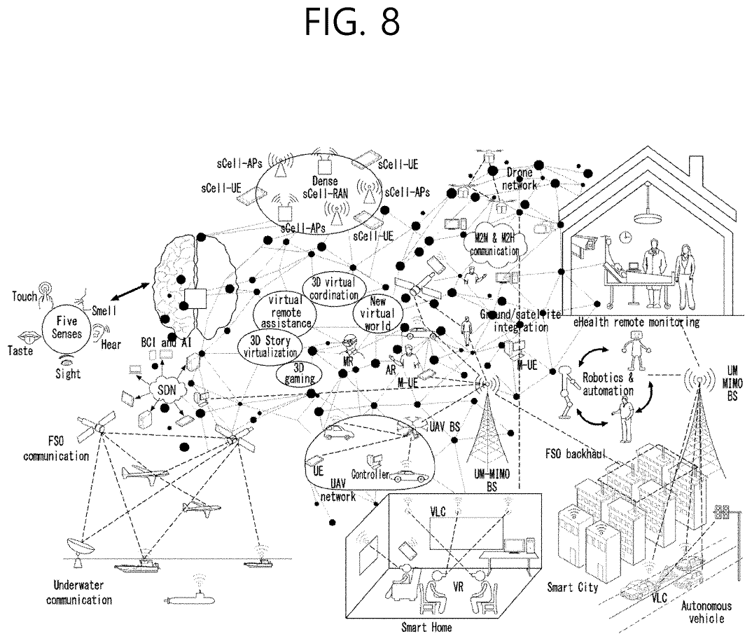

FIG. 8 is a diagram illustrating an example of a communication structure that can be provided in a 6G system applicable to the present disclosure.

Referring to FIG. 8, the 6G system is expected to have 50 times higher simultaneous wireless communication connectivity than the 5G wireless communication system. URLLC, a key feature of 5G, is expected to become a more important technology in 6G communication by providing end-to-end delay of less than 1 ms. At this time, the 6G system will have much better volumetric spectral efficiency than the frequently used area spectral efficiency. The 6G system can provide very long battery life and advanced battery technology for energy harvesting, so that mobile devices in the 6G system may not need to be charged separately.

### Core Implementation Technology of 6G System

### Artificial Intelligence (AI)

Technology which is most important in the 6G system and will be newly introduced is AI. AI was not involved in the 4G system. A 5G system will support partial or very limited AI. However, the 6G system will support AI for full automation. Advance in machine learning will create a more intelligent network for real-time communication in 6G. When AI is introduced to communication, real-time data transmission may be simplified and improved. AI may determine a method of performing complicated target tasks using countless analysis. That is, AI may increase efficiency and reduce processing delay.

Time-consuming tasks such as handover, network selection or resource scheduling may be immediately performed by using AI. AI may play an important role even in M2M, machine-to-human and human-to-machine communication. In addition, AI may be rapid communication in a brain computer interface (BCI). An AI based communication system may be supported by meta materials, intelligent structures, intelligent networks, intelligent devices, intelligent recognition radios, self-maintaining wireless networks and machine learning.

Recently, attempts have been made to integrate AI with a wireless communication system in the application layer or the network layer, but deep learning have been focused on the wireless resource management and allocation field. However, such studies are gradually developed to the MAC layer and the physical layer, and, particularly, attempts to combine deep learning in the physical layer with wireless transmission are emerging. AI-based physical layer transmission means applying a signal processing and communication mechanism based on an AI driver rather than a traditional communication framework in a fundamental signal processing and communication mechanism. For example, channel coding and decoding based on deep learning, signal estimation and detection based on deep learning, multiple input multiple output (MIMO) mechanisms based on deep learning, resource scheduling and allocation based on AI, etc. may be included.

Machine learning may be used for channel measurement and channel tracking and may be used for power allocation, interference cancellation, etc. in the physical layer of DL. In addition, machine learning may be used for antenna selection, power control, symbol detection, etc. in the MIMO system.

However, application of a deep neutral network (DNN) for transmission in the physical layer may have the following problems.

Deep learning-based AI algorithms require a lot of training data in order to optimize training parameters. However, due to limitations in acquiring data in a specific channel environment as training data, a lot of training data is used offline. Static training for training data in a specific channel environment may cause a contradiction between the diversity and dynamic characteristics of a radio channel.

In addition, currently, deep learning mainly targets real signals. However, the signals of the physical layer of wireless communication are complex signals. For matching of the characteristics of a wireless communication signal, studies on a neural network for detecting a complex domain signal are further required.

Hereinafter, machine learning will be described in greater detail.

Machine learning refers to a series of operations to train a machine in order to build a machine which can perform tasks which cannot be performed or are difficult to be performed by people. Machine learning requires data and learning models. In machine learning, data learning methods may be roughly divided into three methods, that is, supervised learning, unsupervised learning and reinforcement learning.

Neural network learning is to minimize output error. Neural network learning refers to a process of repeatedly inputting training data to a neural network, calculating the error of the output and target of the neural network for the training data, backpropagating the error of the neural network from the output layer of the neural network to an input layer in order to reduce the error and updating the weight of each node of the neural network.

Supervised learning may use training data labeled with a correct answer and the unsupervised learning may use training data which is not labeled with a correct answer. That is, for example, in case of supervised learning for data classification, training data may be labeled with a category. The labeled training data may be input to the neural network, and the output (category) of the neural network may be compared with the label of the training data, thereby calculating the error. The calculated error is backpropagated from the neural network backward (that is, from the output layer to the input layer), and the connection weight of each node of each layer of the neural network may be updated according to backpropagation. Change in updated connection weight of each node may be determined according to the learning rate. Calculation of the neural network for input data and backpropagation of the error may configure a learning cycle (epoch). The learning data is differently applicable according to the number of repetitions of the learning cycle of the neural network. For example, in the early phase of learning of the neural network, a high learning rate may be used to increase efficiency such that the neural network rapidly ensures a certain level of performance and, in the late phase of learning, a low learning rate may be used to increase accuracy.

The learning method may vary according to the feature of data. For example, for the purpose of accurately predicting data transmitted from a transmitter in a receiver in a communication system, learning may be performed using supervised learning rather than unsupervised learning or reinforcement learning.

The learning model corresponds to the human brain and may be regarded as the most basic linear model. However, a paradigm of machine learning using a neural network structure having high complexity, such as artificial neural networks, as a learning model is referred to as deep learning.

Neural network cores used as a learning method may roughly include a deep neural network (DNN) method, a convolutional deep neural network (CNN) method and a recurrent Boltzmman machine (RNN) method. Such a learning model is applicable.

### Terahertz (THz) Communication

THz communication is applicable to the 6G system. For example, a data rate may increase by increasing bandwidth. This may be performed by using sub-THz communication with wide bandwidth and applying advanced massive MIMO technology.

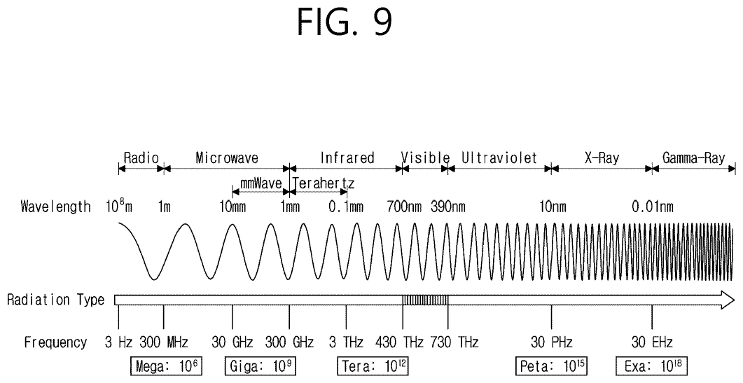

FIG. 9 shows an electromagnetic spectrum applicable to the present disclosure. For example, referring to FIG. 9, THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF.

The main characteristics of THz communication include (i) bandwidth widely available to support a very high data rate and (ii) high path loss occurring at a high frequency (a high directional antenna is indispensable). A narrow beam width generated by the high directional antenna reduces interference. The small wavelength of a THz signal allows a larger number of antenna elements to be integrated with a device and BS operating in this band. Therefore, an advanced adaptive arrangement technology capable of overcoming a range limitation may be used.

### THz Wireless Communication

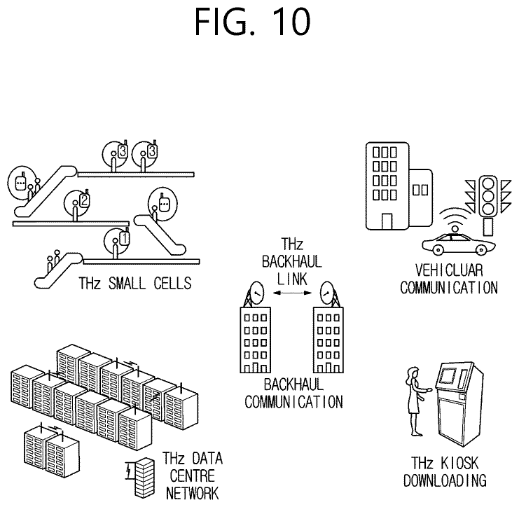

FIG. 10 shows a THz communication method applicable to the present disclosure.

Referring to FIG. 10, THz wireless communication uses a THz wave having a frequency of approximately 0.1 to 10 THz (1 THz=1012 Hz), and may mean terahertz (THz) band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays and has a shorter wavelength than the RF/millimeter wave and thus high straightness and is capable of beam convergence.

### DETAILED EMBODIMENTS OF THE PRESENT DISCLOSURE

In the following, a method and a federated learning system required for efficiently operating wireless operations using a reconfigurable intelligent surface (RIS) are proposed. The RIS may be an intelligent reflect surface (IRS). That is, the RIS may take various forms and may not be limited to a specific designation. In the following, the description is made mainly with reference to the RIS for convenience of explanation, but it may not be limited thereto. Here, an artificial intelligence system may be used to control a radio channel environment using the RIS, which will be described later.

For example, current wireless communication technology may be controlled through endpoint optimization that adapts to a channel environment (H). For example, when optimization is performed at a transmitter and a receiver, the transmitter and the receiver may adjust at least one of beamforming, power control, and adaptive modulation according to the channel environment (H) between the transmitter and the receiver to increase transmission efficiency.

At this time, the channel environment may be random, uncontrolled, and naturally fixed. That is, in conventional communication systems, the channel environment may be in a fixed state, and each endpoint may be controlled to be optimized for the channel environment. Therefore, the transmitter and the receiver perform optimization to adapt to the channel and thereby have no choice but to transmit and receive data. At this time, in environments such as NLOS (non-line of sight) in shadowed areas or 6G THz where signal loss is large and multipath is unlikely to exist, it may be difficult to overcome Shannon's capacity limit only through optimization of endpoints, and as a result it may be difficult to expect throughput meeting desired requirements.

Considering the above, in a new communication system, communication may be performed based on a Smart Radio Environment (SRE). In this case, in the smart radio environment, a factor capable of controlling a radio channel together with a transmitter and receiver by using an RIS may be utilized.

That is, a factor related to a radio channel may be added as a factor used to optimize wireless communication transmission. Through this, problems that cannot be solved in conventional communication systems, such as resetting a channel or overcoming Shannon's channel capacity limit, may be made possible. However, since the measurement of the channel added by the RIS in the smart radio environment and simultaneous consideration of the RIS with the transmitter and receiver are required, it may be necessary to optimize wireless communication transmission, and accordingly, the optimization process may become complicated.

In addition, as artificial intelligence applications such as federated learning increase, wireless distributed computation may be required. Here, the wireless distributed computation is a process in which multiple devices perform distributed computation using wireless communication for a specific objective. For example, several UEs may train a single artificial intelligence model in a distributed manner for the purpose of artificial intelligence learning. Another example is that, to utilize autonomous driving technology, several sensors are installed to measure road condition information, and a base station may need to simultaneously receive sensor data from multiple sensors. For personalized broadcasting, communication may be required to simultaneously transmit data to a device capable of storing a large amount of data in bulk. That is, wireless federated computation may take various forms and may not be limited to a specific term. In the following, for convenience of explanation, wireless computation performed using AirComp technique is mainly described, but the disclosure is not limited thereto.

The AirComp technique is being studied in various ways. For example, it may be implemented in such a manner that UEs performing AirComp transmit local parameters by utilizing the same resource. In this case, the base station may naturally obtain the sum of the local parameters due to the superposition characteristics of analog signals. Another example is a case where UEs transmit signals after performing pre-processing, and the base station interprets the superimposed signals over the air through post-processing, in which various functions such as weighted mean and geometric mean may be implemented according to the pre-processing and post-processing functions.

When using the over-the-air computation (AirComp) technology, signals are superimposed over the air, and thus, if the transmission power of a particular UE is too strong, a situation may occur where the signals of other UEs are ignored. Therefore, in order to achieve the desired wireless computation, the base station may have to perform power allocation for each UE. Since it requires allocating much power to devices located in shadow areas, it may be difficult to utilize the AirComp technique with optimization of only the transmitter and receiver. To overcome such problems, RIS-based AirComp technique has emerged, enabling an environment in which data may be transmitted and received simultaneously over the air. However, there may be the following problems in using the RIS-based AirComp technique.

For example, there may be limitations in controlling the RIS using the alternating optimization (AO) algorithm applied in a smart radio environment, together with the limitations of current wireless communication technology.

In more detail, in a conventional communication system, operation could be performed by a method that approaches Shannon's channel capacity limit through control of the transmitter and receiver under a fixed radio channel environment. However, in a poor NLOS environment such as a shadow area, transmission and reception may be almost impossible due to the limitation of channel capacity. For example, in an NLOS channel environment, the transmitter may increase transmission power to improve the limitation of channel capacity, but the magnitude of noise and interference may also increase accordingly. In such a case, in an environment such as 6G THz where signal loss is large and multipath is difficult to exist, there may be a limitation in overcoming Shannon's channel capacity limit with optimization of only the transmitter and receiver.

Here, for example, in a new communication system (e.g. 6G), there is a need to satisfy requirements for providing new services such as Mobile Broadband Reliable Low Latency Communication (MBRLLC), Massive Ultra-Reliable, Low Latency Communications (mURLLC), Human-Centric Services (HCS), and Convergence of Communications, Computing, Control, Localization, and Sensing (3CLS), and for this purpose, communication based on a smart radio environment may be required.

In addition, for example, many relays are currently used to increase the coverage of base station cells and to support shadow areas. However, although the use of relays may increase transmission efficiency, it may additionally generate interference signals to other users. Therefore, there may be a limitation in terms of overall communication resource efficiency. Furthermore, the use of relays may require high additional cost and energy and may make it difficult to manage complex and mixed interference signals. Also, for example, when a half-duplex scheme is used, spectral efficiency may be reduced, and relays may also affect spatial utilization or aesthetics.

On the other hand, in a smart radio environment, the radio channel environment may be adjusted using a RIS. At the same time, by performing optimization together at both the transmitter and the receiver, a solution may be provided to overcome Shannon's channel capacity limit in the Smart Radio Environment, which will be described later.

However, in addition to the channel between the base station and the UE, it is also necessary to consider the channels between the base station and the RIS and/or between the RIS and the UE. Furthermore, while it was sufficient in the conventional system to optimize only the transmitter and receiver according to the environment, in the Smart Radio Environment, the RIS also needs to be controlled.

In addition, since the value may depend on the optimization of the transmitter and receiver, the complexity of optimization may increase. Here, the Alternating Optimization (AO) algorithm used for optimization may be repeatedly performed until convergence, which may cause a burden in that all channels must be measured.

In the case of using AirComp technique, the channel environments of devices located in shadow areas may be improved using the RIS, however, the difficulty of optimization considering the RIS still remains.

Hereinafter, a method and artificial intelligence system for performing optimization in a smart radio environment using the RIS will be described in consideration of the above points.

Also, for example, Table 2 may represent terminology in view of the foregoing description, and based thereon, a method and artificial intelligence system for performing optimization in a smart radio environment using the RIS will be described below.

TABLE 2
Federated Learning: Federated Learning
Reconfigurable Intelligent Surface (RIS): Reconfigurable
Intelligent Surface
Smart Radio Environment (SRE): Smart Radio Environment
Mobile Broadband Reliable Low Latency Communication (MBRLLC):
6G service require high speed-high reliability-low latency (eg. BCI)
Massive Machine Type Communications (mMTC): Massive Machine
Type Communications
Massive Ultra-Reliable, Low Latency communications (mURLLC):
mMTC + URLLC
quality-of-physical-experience (QoPE): QOS + QOE +
physiological response
Human-Centric Services (HCS): communication based on the QoPE
Convergence of Communications, Computing, Control, Localization,
and Sensing (3CLS)

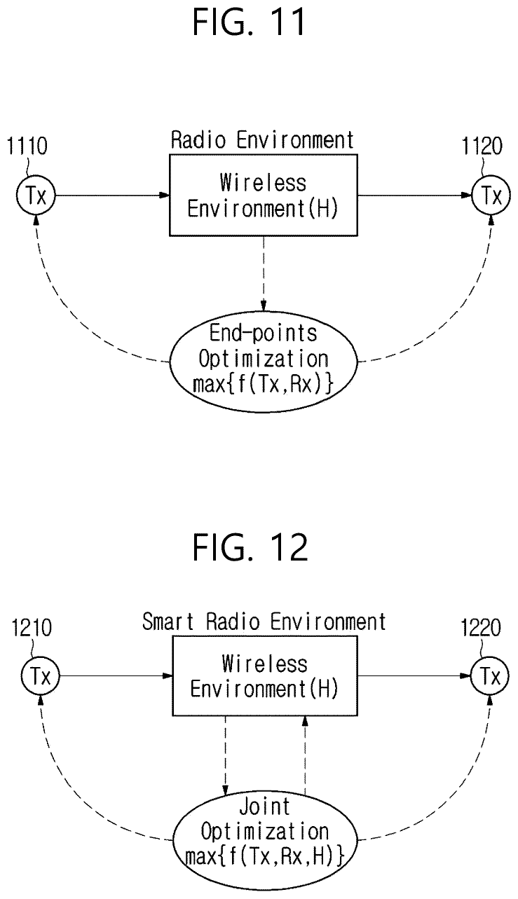

FIG. 11 is a diagram illustrating a radio channel environment according to an embodiment of the present disclosure. Referring to FIG. 11, in a conventional communication system, the radio channel environment (H) is naturally fixed and may be in an uncontrollable random state. Therefore, the transmitter 1110 and the receiver 1120 may find optimized transmission and reception methods by adapting to the channel. The transmitter 1110 and receiver 1120 may measure the channel state through a signal (e.g., a reference signal) and be controlled so that optimization is performed based on the measured channel state. However, as described above, in environments such as the terahertz band where signal loss is high and multipath application is difficult, or in NLOS environments such as shadow areas, there may be limitations in data transmission. For example, [Equation 1] below may represent Shannon's capacity limit. Even if precoding and processing are applied to increase the transmission signal P in [Equation 1], when the magnitude of the channel |H| is small, there may be a limit to increasing channel capacity.

When the radio channel environment is fixed, there is a limit to increasing channel capacity based on [Equation 1]. In this case, communication using an RIS may secure multiple paths between the transmitter 1110 and the receiver 1120, and the aforementioned channel may be enhanced. In other words, in a smart radio environment, the radio channel environment based on an RIS may be a controllable factor, thereby increasing channel capacity.

$$C = log ( 1 + \frac{{\vert HP \vert}^{2}}{{σ}^{2}} ) \qquad [ Equation 1 ]$$

For example, FIG. 12 is a diagram illustrating a smart radio environment according to an embodiment of the present disclosure. Referring to FIG. 12, in a smart radio channel environment, the radio channel |H| may be a factor for optimization. More specifically, in FIG. 11 described above, endpoint optimization may be performed at the transmitter 1110 and receiver 1120 based on “max{f(Tx, Rx)},” as described above. However, in FIG. 12, endpoint optimization may be performed at the transmitter 1210 and receiver 1220 based on “max{f(Tx, Rx, H)}.” That is, in a smart radio environment, the channel |H| based on an intelligent reflecting surface may be used as a factor for optimization.

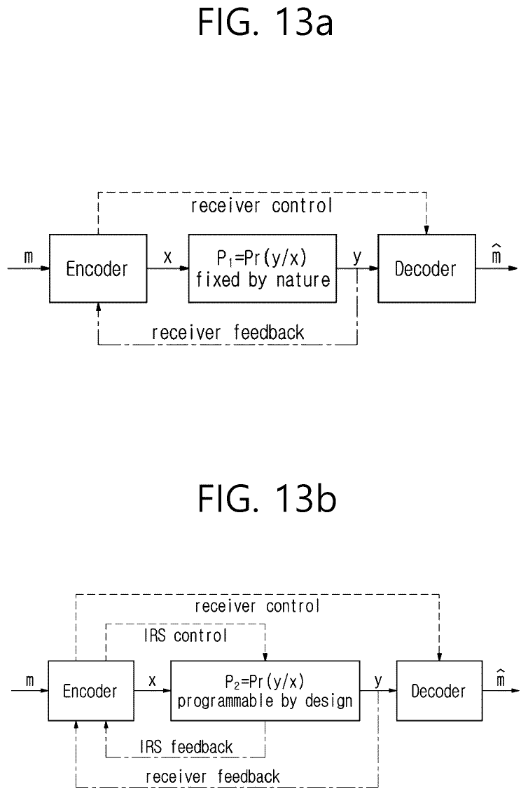

FIGS. 13a and 13b are diagrams illustrating a conventional radio channel environment and a smart radio channel environment according to an embodiment of the present disclosure. For example, referring to FIG. 13a, the conventional radio channel environment may be P1. Also, referring to FIG. 13b, the smart radio channel environment may be P2. When the signal x is transmitted from the transmitter through the radio channel in FIGS. 13a and 13b, the receiver may receive a signal y. In the conventional radio channel environment, the probability P1 is fixed, and the receiver (decoder) may send feedback to the transmitter through measurement of the transmitted signal. The transmitter may perform optimization so as to adapt to the radio channel environment based on the feedback from the receiver. In a more specific example, the receiver may measure a Channel Quality Indicator (CQI) for the transmission signal based on the reference signal transmitted by the transmitter and feed it back. The transmitter may adjust the Modulation Coding Scheme (MCS) based on the feedback information and provide this information to the receiver to perform communication.

In contrast, referring to FIG. 13b, in the smart radio channel environment, the radio channel environment P2 may be recognized and changed through RIS control. At the same time, the receiver may perform measurement on the received transmission signal and transmit feedback about it to the transmitter. That is, the transmitter may perform optimization by receiving feedback information based on RIS control and feedback information from the receiver. In this case, the transmitter may adjust the RIS to change the radio channel environment, and optimization may be performed considering both the radio channel environment and the transmitter.

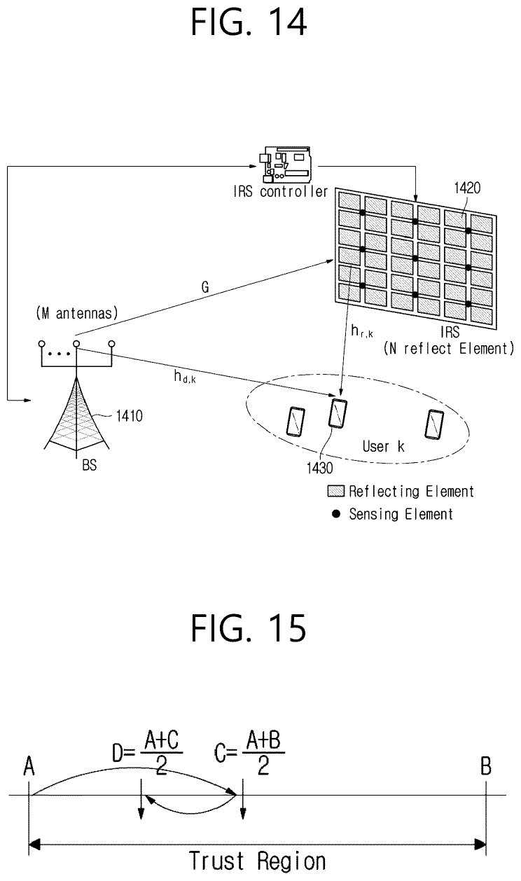

More specifically, FIG. 14 is a diagram illustrating a method for performing optimization in a smart radio channel environment according to an embodiment of the present disclosure. Referring to FIG. 14, in the smart radio channel environment, a reconfigurable intelligent surface (RIS) 1420 may exist between a base station 1410 and a UE 1430. For example, a signal transmitted from the base station 1410 may have a direct transmission path to the UE 1430 and a reflected transmission path via the RIS 1420. That is, in the smart radio channel environment, a radio channel G may exist between the base station 1410 and the RIS 1420, a radio channel h_{r,k} between the RIS 1420 and the UE 1430, and a direct radio channel h_{r,k} between the base station 1410 and the UE 1430. Here, based on the control of the RIS 1420, the radio channel G between the base station 1410 and the RIS 1420 and the radio channel h_{r,k} between the RIS 1420 and the UE 1430 may be varied. Therefore, optimization in the smart radio channel environment may be performed considering the above-described radio channel environment.

More specifically, when the base station 1410 transmits a signal to a UE k 1430, the base station transmits beamforming vector for the UE k 1430 may be represented as wₖ, the signal transmitted to the UE k 1430 as sₖ, and the received noise as nₖ. In this case, the signal received by the UE k 1430 from the base station 1410 in an environment using the RIS 1420 may be expressed as [Equation 2] below, and each channel may be defined as shown in [Table 3] below.

$$y = ( {h}_{r , k} Φ G + {h}_{d , k} ) {w}_{k} {s}_{k} + {n}_{k} \qquad [ Equation 2 ]$$

TABLE 3
- h_{d,k} ∈ [symbol] : Channel from BS to user k, h_{r,k} ∈ [symbol] : Channel from RIS
to user k
- G ∈ [symbol] : Channel from BS to RIS, wₖ ∈ [symbol] : transmit beamforming
vector for signal sₖ
- Φ = diag(β1e^{jθ1} ... βNe^{jθN}): Phase and amplitude coefficient for element
n, β ∈ [0, 1], θ ∈ [0, 2π]
$- {n}_{k} \sim C 𝒩 ( 0 , {σ}_{k}^{2} ) : AWGN at user k$

Here, the signal noise ratio (SNR) received by UE k 1430 may be expressed as [Equation 3] below.

$$γ = \frac{( {h}_{r , k} Φ G + {h}_{d , k} ) {w}_{k}}{{σ}_{k}^{2}} \qquad [ Equation 3 ]$$

Accordingly, when configuring a smart radio environment (SRE) to optimize the received SNR, it may be the case of setting the RIS control and the transmit beamforming as shown in [Equation 4] below.

$${max}_{{w}_{k} , Φ} \frac{{\vert ( {h}_{r , k} Φ G + {h}_{d , k} ) {w}_{k} \vert}^{2}}{{σ}_{k}^{2}} \qquad [ Equation 4 ]$$

At this time, considering maximum-rate transmit in MIMO, the transmit beamforming wₖ of UE k 1430 may be expressed as [Equation 5] below.

$${w}_{k}^{*} = \sqrt{{P}_{max}} \frac{{( {h}_{r , k} Φ G + {h}_{d , k} )}^{H}}{‖ ( {h}_{r , k} Φ G + {h}_{d , k} ) ‖} \qquad [ Equation 5 ]$$

Here, Pₘₐₓ may represent the maximum transmit power of the RIS, and by substituting wₖ* into the optimization equation for wₖ and φ, the optimization may be expressed as [Equation 6] below.

$${max}_{Φ} {‖ {h}_{r , k} Φ G + {h}_{d , k} ‖}^{2} , s . t . \vert {Φ}_{i , i} \vert = 1 , ∀ i = 1 , 2 , 3 , … , N$$

When the RIS control value p is determined, wₖ may be determined through computation. Here, an AO (Alternating Optimization) algorithm may be used to solve the above-described optimization problem. For example, the AO algorithm may determine a trust region for each RIS element using channel information (h_{d,k}, h_{r,k}, G), as illustrated in FIG. 15. Further, a binary decision may be repeatedly performed until the value of the objective function (Objective Value) converges, thereby obtaining θₙ. Here, the upper bound of the convergence value may be βₙ(θₙ)=1 in the case of an ideal RIS. In one example, in FIG. 14, the RIS may repeat the above-described operation to find an optimized value for each RIS element.

The Alternating Optimization (AO) algorithm needs to be repeated until convergence. Moreover, since the optimized value must be derived for each RIS element, the complexity and computational load may increase. In this case, as the number of base station antennas M and the number of RIS elements N increase, the complexity and computation amount may also increase, which may limit practical computation. In addition, when optimizing the Alternating Optimization (AO) algorithm, measurement values of all channels including the RIS may be required, and considering the above, there may be a limitation in optimization.

The differences between an RIS and a relay may be represented as shown in [Table 4] below.

TABLE 4

| | | Power | | | | Hardware | Energy |
|---|---|---|---|---|---|---|---|
| Technology | Duplex | budge | Noise | Compatibility | Interference | complexity | consumption |
| RIS | Full | Passive, | No noise | Very high | Very low | Very low | Low |
| | | Low | | | | | |
| AF relay | Half/Full | Active, | Additive | Low | High | High | High |
| | | high | noise | | | | |
| DF relay | Half/Full | Active, | Additive | Low | High | High | high |
| | | high | noise | | | | |

The biggest difference between an RIS and a relay is whether an amplifier is used. The relay amplifies the received signal as it is and transmits it, or decodes the signal, performs computation, and then transmits the encoded signal after amplification. In contrast, an RIS sends the received signal through reflection or refraction, so communication using an RIS does not require an amplifier, allowing power-efficient communication.

Therefore, the present disclosure proposes a transmission and reception method using AirComp technique in which artificial intelligence, such as federated learning, and IoT devices, such as various sensor or etc., utilize an RIS in a communication system. By improving the channel gains of devices in shadowed areas through the RIS, waste of communication resources may be caused by influence of some UEs or devices located in shadowed areas where communication is impossible. That is, due to some devices in shadowed areas, overall communication performance may deteriorate, or some devices may monopolize the base station's resources, resulting in a situation where communication between the base station and the UEs is impossible. By using an RIS, the channel gains of UEs or devices in shadowed areas may be improved, and additionally, if grouping is performed based on the RIS when selecting devices, the performance of the AirComp technique may be enhanced.

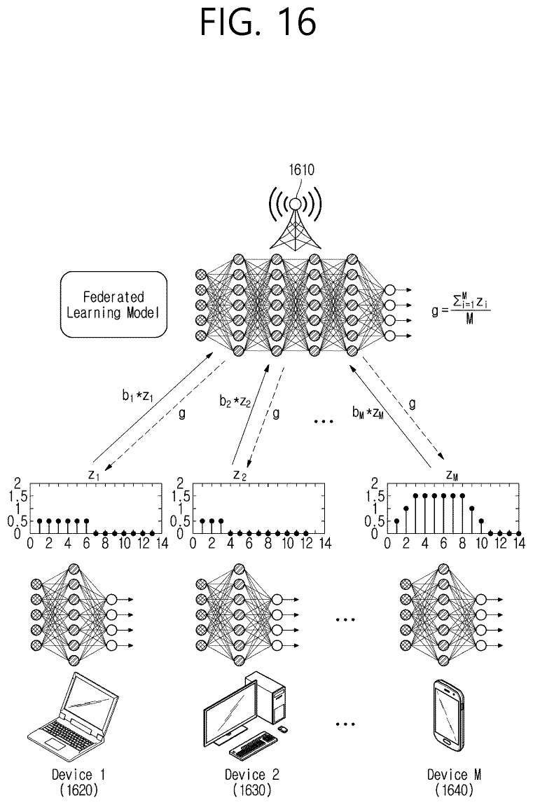

FIG. 16 is a diagram illustrating the structure of a federated learning system using AirComp technique according to an embodiment of the present disclosure. Referring to FIG. 16, the base station 1610 may train a federated model through each UE 1620 to 1640. The base station 1610 transmits the global model g to the devices 1620 to 1640 participating in the federated learning. Each UE 1620 to 1640 generates a local model (z₁ to zₘ) through artificial intelligence training based on the global model g. Since continuous transmission and reception of large amounts of data may be required for federated learning, AirComp technique that allows simultaneous transmission of data may be utilized. Each UE 1620 to 1640 participating in the federated learning transmits to the base station 1610 by multiplying its transmission coefficient (b₁ to bₘ). The base station 1610 averages the received signals to determine a new global model and transmits the new global model to each UE 1620 to 1640. In this embodiment, the new global models are determined by the arithmetic average of the new models of each device 1620 to 1640, but they may also be implemented using geometric average, weighted average, or other methods.

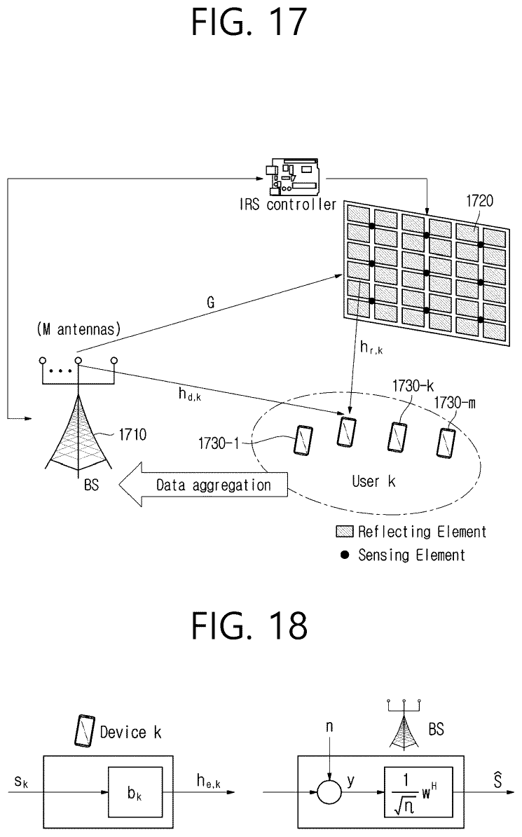

FIG. 17 is a diagram illustrating an AirComp system using an RIS 1720 and the channel information according to an embodiment of the present disclosure. Referring to FIG. 17, the base station 1710 may perform data aggregation from UEs 1730-1 to 1730-m using AirComp technique with the RIS 1720. Since the AirComp system is a communication method in which the base station 1710 aggregates the information transmitted by connected UEs 1730-1 to 1730-m over the air, the channel information is indicated in the direction from the UE to the base station 1710. In time division duplexing (TDD) system, transmission and reception may occur at the same frequency. Therefore, channel reciprocity may be assumed in the AirComp system. In FIG. 17, h_{r,k} represents the channel from the k-th UE 1730-k to the RIS 1720, G represents the channel from the RIS 1720 to the base station 1710, and h_{d,k} represents the channel from the k-th UE 1730-k to the base station 1710. When the UE 1730-k transmits data sₖ, the base station 1710 receives data y as shown in the following [Equation 7].

$$y = {\sum }_{k = 1}^{m} ( G Φ {h}_{r , k} + {h}_{r , k} ) {b}_{k} {s}_{k} + n \qquad [ Equation 7 ]$$

In [Equation 7], bₖ represents the transmission coefficient of UE 1730-k, φ represents the symmetric phase-shift matrix of the RIS 1720, m represents the number of UEs participating in the AirComp system, and n represents the noise that occurs when the base station 1710 receives a signal, which corresponds to AWGN that can be expressed as n∈C^{M}~CN(0,σ²).

The transmission coefficient bₖ of the UE is determined based on the channel information of each UE 1730-1 to 1730-m and is used as a factor to enable the base station 1710 to aggregate the signals transmitted from each UE 1730-1 to 1730-m.

FIG. 18 is a diagram illustrating a transmitter and receiver structure of the UE and the base station for an AirComp system according to an embodiment of the present disclosure. Referring to FIG. 18, the base station may estimate the signals transmitted by the UEs using a decoding vector. Each UE transmits to the base station the value obtained by multiplying the data sₖ by its transmission coefficient. In FIG. 18, h_{e,k} represents the effective channel, which refers to the radio channel including the RIS.

The definition of the effective channel is as shown in [Equation 8].

$${h}_{e , k} = G Φ {h}_{r , k} + {h}_{r , k} \qquad [ Equation 8 ]$$

The base station receives a signal y, which is the sum of the signals transmitted by each device with AWGN added. The estimated signal s may be expressed as in [Equation 9].

$$\hat{s} = \frac{1}{\sqrt{η}} {w}^{H} y \qquad [ Equation 9 ]$$

In [Equation 9], η represents a power normalization factor of a UE, and w represents a decoding vector of the base station.

η and w may be determined through an optimization process to minimize a mean squared error (MSE). A performance of the AirComp system using the RIS may be represented using the MSE, which expresses a difference between an estimated signal and a reference signal. The MSE may be determined as shown in [Equation 10] below.

$$M S E = \frac{{δ}^{2} {‖ w ‖}^{2}}{{P}_{M} {min}_{k} {‖ {w}^{H} {h}_{e , k} ‖}^{2}} , \qquad [ Equation 10 ]$$

$${h}_{e , k} = G Φ {h}_{r , k} + {h}_{r , k} {\vert {b}_{k} \vert}^{2} \leq {P}_{M} , ∀ k$$

In [Equation 10], Pₘ represents a maximum power of a UE.

Therefore, to maximize the performance of the AirComp system using the RIS, the values of the decoding vector w and the reflection pattern φ of the RIS, which minimize the MSE in [Equation 10] below, may be determined.

$${min}_{w , Φ} ( {max}_{k} \frac{{‖ w ‖}^{2}}{{‖ {w}^{H} {h}_{e , k} ‖}^{2}} ) , \qquad [ Equation 11 ]$$

$$subject to 0 \leq {θ}_{n} \leq 2 π , ∀ n = 1 , … , N$$

To determine the values of the decoding vector w and the reflection pattern φ of the RIS through [Equation 11], various methods may be used. For example, a semi-definite relaxation (SDR) method based on alternating optimization (AO) or an approximation method such as the difference of convex (DC) algorithm may be used.

Based on the values of the decoding vector w and the reflection pattern φ of the RIS that minimize the MSE, the transmission coefficient bₖ and the power control factor η of the UE may be determined through [Equation 12] and [Equation 13] below.

$${b}_{k} = \sqrt{η} \frac{{( {w}^{H} {h}_{e , k} )}^{H}}{{‖ {w}^{H} {h}_{e , k} ‖}^{2}} , ∀ k \qquad [ Equation 12 ]$$

$$η = {P}_{M} {min}_{k} {‖ {w}^{H} {h}_{e , k} ‖}^{2} \qquad [ Equation 13 ]$$

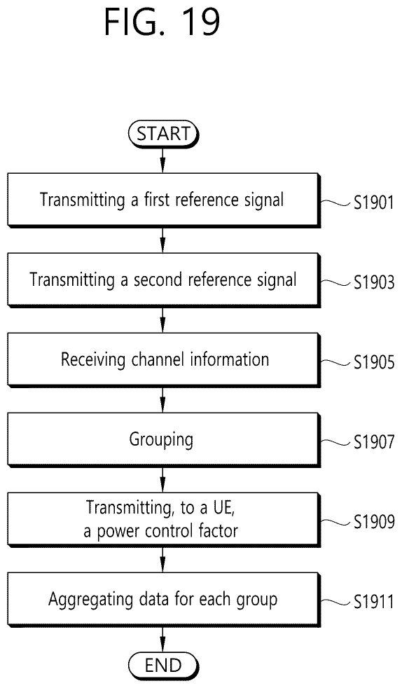

FIG. 19 is a diagram illustrating an operation method of a base station in an AirComp system using an RIS according to an embodiment of the present disclosure. Referring to FIG. 19, the base station may group UEs and perform data aggregation using AirComp technique.

In Step S1901, the base station transmits a first reference signal to UEs. The first reference signal may be a reference signal used to measure the channel state between the base station and the UEs without using the RIS. The base station may also measure the channel state in which the influence of the RIS is removed by transmitting a control signal to deactivate the RIS.

In Step S1903, the base station transmits a second reference signal to the UEs. The second reference signal may be a reference signal used to measure the channel state between the base station and the UEs when the RIS is utilized. In the case of the base station and the RIS, since their positions are fixed or continuous transmission and reception may occur, the channel between the base station and the RIS may be pre-measured. Based on the pre-measured channel information between the base station and the RIS, the base station may determine a beamforming vector or the like and transmit the second reference signal.

In Step S1905, the base station receives channel information from the UEs. The channel information may include the channel gain of the channels measured in Steps S1901 and S1903. The channel state information may include not only the channel gain but also location information of the UEs.

In Step S1907, grouping is performed by classifying UEs that will participate in AirComp communication. For example, the base station may classify the UEs into those that will participate in AirComp and those that will not, based on a predetermined threshold. In another example, the base station may classify UEs with the same channel that has the highest channel gain into the same group. In another example, grouping may be performed based on location information into UEs located in shadowed areas and UEs no located on shadowed areas. In yet another example, when multiple RISs exist, grouping may be performed based on location information to classify UEs into a direct communication group, a group using a first RIS, and a group using a second RIS. The grouping criteria may vary depending on the circumstances of the system implementer, and no particular method is excluded.

In Step S1909, the base station transmits the power control factor to the UEs. To determine the power control factor, the base station determines parameter values for each group in order to utilize the AirComp technique. The parameter values may be parameter values that reduce the MSE of the received signal, based on the channel information received by the base station. The parameter values determined at this time may not theoretically correspond to the values having the minimum MSE. The parameter values determined by the base station may include at least one of the decoding vector or the reflection pattern of the RIS.

A specific method is not excluded from the method of transmitting a power control factor. For example, the base station may transmit the power control factor to the UEs belonging to the first group, perform Step S1909 for the first group, and then transmit the power control factor to the UEs belonging to the second group. In another example, the base station may broadcast the power control factor to both the first and second groups of UEs, and then perform Step S1909 for the first group.

In Step S1909, the base station aggregates data for each group using the AirComp technique. The UEs belonging to each group may transmit signals over the air using the same communication resource. The signals transmitted through the same communication resource may overlap in the wireless domain and appear as a single signal. By using this overlapping process in the wireless domain, the base station may compute a specific required operation. For example, in the uncoded AirComp scheme, UEs may transmit signals simultaneously over the same frequency band in the wireless domain. The base station receives the superimposed signals as a single signal, and the value indicated by the received signal may represent the sum of the values indicated by the signals transmitted by the UEs. Therefore, although the base station cannot distinguish each individual signal transmitted by the UEs, the sum of the values represented by the transmitted signals can be computed without additional operations. In addition to the uncoded AirComp scheme, a coded AirComp scheme using the signSGD algorithm may also be used.

The base station may receive, using a decoding vector determined for each group, data superimposed in the wireless domain that the UEs have partitioned and transmitted, and may perform federated learning based on the received data.

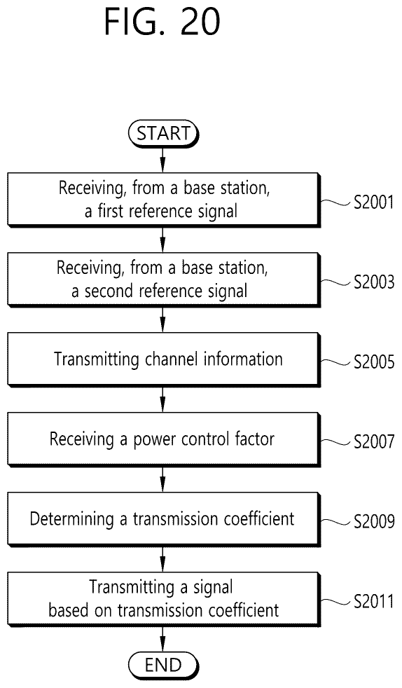

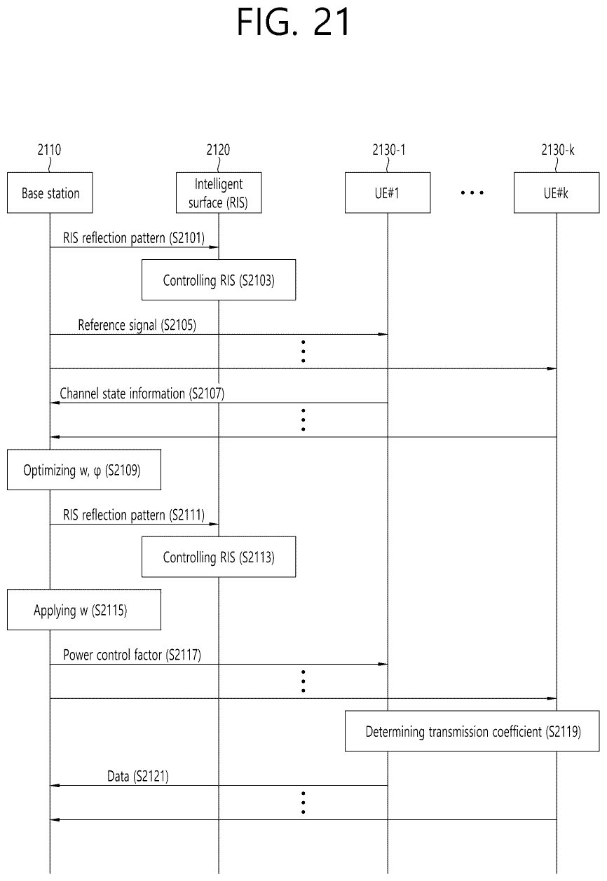

FIG. 20 is a diagram illustrating an operation method of a UE participating in an AirComp system using RIS according to an embodiment of the present disclosure. Referring to FIG. 20, a UE may transmit channel information to a base station and transmit data to the base station to perform AirComp. In step S2001 and step S2003, the UE receives a first reference signal and a second reference signal from the base station. The first reference signal may be a reference signal for measuring a channel that directly communicates between the base station and the UE. The second reference signal may be a reference signal for measuring a channel through which the base station communicates with the UE by using the RIS. If a plurality of RISs exist and communication without using the RIS is impossible, the first reference signal and the second reference signal may be reference signals for measuring channels using each RIS.

In step S2005, the UE that has received at least one or more reference signals transmits information on the channel having the largest channel gain to the base station. Step S2003 may be replaced by a method in which the UE transmits information on all channel information to the base station. The channel information may also include a location of the UE. Based on the received channel information, the group to which the UE belongs is determined.

In step S2005, in order to perform AirComp, the UE receives a power control factor from the base station. The AirComp technique may be applied to each group. Accordingly, if it is not the turn of its own group, the UE may not perform the operations of steps S2009 and S2011.

In step S2009, the UE determines a transmission coefficient based on the power control factor. The transmission coefficient may be determined through [Equation 12].

In step S2007, the UE transmits distributed processed data based on the transmission coefficient. The base station may aggregate data for each group.

FIG. 21 is a diagram illustrating a signal flow between the base station 2110, RIS 2120 and UEs 2130-1 to 2130-k in an AirComp system using RIS according to an embodiment of the present disclosure. Referring to FIG. 21, the base station 2110 may determine the reflection pattern of the RIS to enhance the channel gains of UEs located in shadowed areas and aggregate data using the AirComp technique. In step S2101, the base station 2110 transmits the reflection pattern to the RIS 2120 to measure the channel states for the UEs 2130-1 to 2130-k participating in AirComp communication. The reflection pattern of the RIS 2120 may be provided in the form of a square wave to mitigate shadow areas or as a beam pattern learned based on information of each UE 2130-1 to 2130-k. The information of each UE 2130-1 to 2130-k may include connected UEs corresponding to angular directions and channel magnitudes.

In step S2103, the RIS 2120 controls the elements of the RIS based on the received reflection pattern. Through step S2103, the reflection angles of the elements of the RIS 2120 may be adjusted, and the base station 2110 may provide at least one channel to each UE 2130-1 to 2130-k by adjusting the reflection pattern.

In step S2105, the base station 2110 transmits reference signals to each UE 2130-1 to 2130-k to measure channel information. The reference signals may include at least one of cell-specific reference signal (CRS), UE-specific reference signal (UE-RS), demodulation reference signal (DM-RS), channel state information reference signal (CSI-RS), MBSFN reference signal, positioning reference signal (PRS), phase tracking reference signal (PTRS) or etc. The method by which the base station 2110 transmits the reference signals is not specifically limited. For example, the base station 2110 may transmit reference signals to all UEs 2130-1 to 2130-k using a broadcast method.

In step S2107, each UE 2130-1 to 2130-k that has received the reference signals transmits the channel state information to the base station 2110.

In step S2109, the base station 2110 determines the decoding vector w and the reflection pattern φ of the RIS that minimize the objective function, MSE, based on the received channel state information. The objective function for optimization may be as represented in [Equation 10]. To minimize the objective function, an alternating optimization (AO) algorithm may be used, and artificial intelligence may be applied.

In steps S2111 and S2113, the base station 2110 transmits the reflection pattern φ determined in step S2109 to the RIS 2120, and the RIS 2120 controls each of its elements based on the received reflection pattern φ.

In steps S2115 and S2117, the base station 2110 configures the decoding vector determined in step S2109 as the base station's decoding vector and transmits the power control factor η to each UE 2130-1 to 2130-k. The power control factor η may be determined through [Equation 13] based on the decoding vector w and the RIS reflection pattern φ.

In step S2119, each UE 2130-1 to 2130-k determines the transmission coefficients b₁ to bₖ. The transmission coefficients may be determined through [Equation 12] based on the decoding vector w and the channel information of each UE.

In step S2121, each UE 2130-1 to 2130-k applies the determined transmission coefficients and transmits data. The base station 2110 receives the data to which the transmission coefficients have been applied and may estimate the signals transmitted by each UE according to [Equation 9].

Although resources such as antenna beamforming and available power at the base station are limited, there may be many UEs to aggregate. For an efficient communication system, the base station may need a device selection process. Since the channel gains of UEs vary, a few UEs in shadowed areas may increase the overall MSE, which is a performance metric of the AirComp system, thereby degrading the performance of the AirComp system. Therefore, to improve the performance of the AirComp system, the base station may need to classify UEs with similar channel gains into the same group. Additionally, to enhance channel gains, the base station may communicate with UEs in groups with lower channel gains by using the RIS.

When performing AirComp communication using the RIS, one method may involve simultaneously using the direct channel and the reflected channel through the RIS. When optimization is performed while considering both the direct channel and the reflected channel, the base station may require a large amount of computation due to the complex algorithms. Especially when there are a large number of UEs, the base station may need to limit the number of UEs involved. If UEs are randomly selected during the selection process, computational waste may accumulate. Therefore, when a UE selection process is necessary, the base station may group UEs considering the RIS and control the RIS to ensure uniform channel gains. Through grouping, the base station may reduce the computation required for optimization while simultaneously improving the performance of the AirComp system.

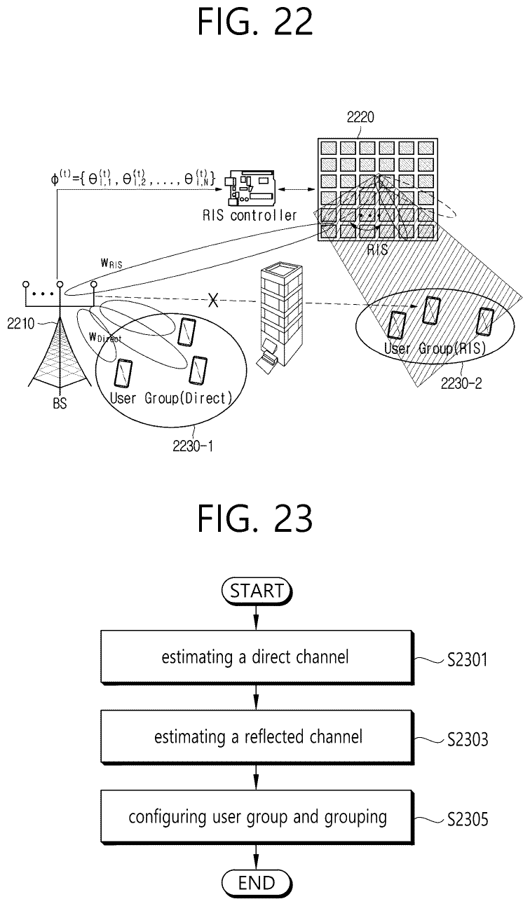

FIG. 22 is a diagram illustrating an AirComp system environment using a RIS according to an embodiment of the present disclosure. Referring to FIG. 22, for device selection, a classification may be performed into a direct channel group 2230-1 that communicates with the base station 2210 through the direct channel and a reflected channel group 2230-2 that communicates through the intelligent surface 2220. When aggregating data using the AirComp technique, the UEs belonging to each group 2230-1 and 2230-2 may transmit and receive signals with the base station 2210 through the channels corresponding to their respective groups 2230-1 and 2230-2. In the case where multiple RISs exist, the reflected channel group may be plural. Moreover, if the base station 2210 has difficulty processing all UEs in the direct channel group 2230-1 at once, the base station 2210 may further divide the direct channel group 2230-1 into multiple groups. As another example, the base station may perform grouping of UEs with similar channel gains to reduce the MSE of the AirComp system.

The following FIGS. 23 to 25 illustrate specific embodiments in which the base station performs grouping.

FIG. 23 is a diagram illustrating a method of performing grouping for UEs that will utilize AirComp technique using an RIS, according to an embodiment of the present disclosure. Referring to FIG. 23, the base station may determine UEs that will participate in AirComp and perform grouping. In step S2301, the base station estimates a direct channel without using the RIS. The base station may transmit a stop control signal to the RIS so as to estimate a channel without the influence of the RIS. At this time, the base station may transmit a reference signal to the UE and cause the UE to transmit a report on the reference signal.

In step S2303, the base station estimates a reflection channel using the RIS. Since a plurality of RISs may be used, there may be at least one reflection channel. When there are multiple reflection channels, the base station may transmit a control signal for a first RIS with a predetermined reflection pattern, and transmit a signal to stop control for a second RIS. The reflection pattern for the first RIS may be determined by referring to the previously measured channel information between the base station and the first RIS. In order to measure the environment of each reflection channel, the base station may transmit multiple reference signals to the UE and cause the UE to transmit reports for all reflection channels. In another example, the base station may cause each UE to transmit the channel and channel gain that has the largest channel gain among each reflection channel.

In step S2305, the base station may configure the UEs to participate in AirComp communication into user groups based on the channel information received from the UE, and may further perform grouping per channel. For example, the base station may determine all UEs as a user group and then perform grouping by channel. The method by which the base station performs grouping is not limited to a specific approach. For example, the base station may allow only UEs having a channel gain exceeding a certain threshold to participate in AirComp communication. In another example, the base station may allow a predetermined number of UEs in order of highest channel gains to participate in AirComp communication. The base station may further perform grouping per channel for UEs belonging to the determined user group. For example, the base station may perform grouping into a direct channel group that does not use the RIS and a first reflection channel group that uses a first RIS. In another example, when multiple RISs are used, multiple reflection channel groups may be classified. The method for determining which group each UE belongs to may be based on at least one piece of information, such as the channel gain measured by each UE, a location of the UE or etc.

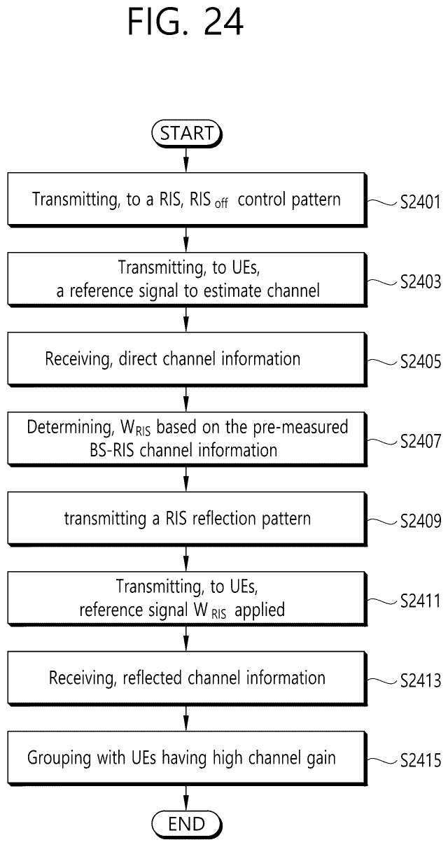

FIG. 24 is a diagram illustrating an operation method of a base station that performs grouping based on channel gain using an RIS according to an embodiment of the present disclosure. Referring to FIG. 24, the base station may aggregate channel information from all UEs and classify the UEs into a direct channel group and an RIS channel group. In step S2401, the base station transmits an RIS_{off} control signal to the RIS. The RIS_{off} control signal is a signal for stopping the operation of the RIS and is used when receiving information on the direct channel without using the RIS.

In step S2403, the base station transmits reference signals to the UEs. The UEs that have received the reference signals from the base station transmit their channel gains to the base station.

In step S2405, the base station receives direct channel information. The base station that has received the direct channel information stores the direct channel information for comparison with reflection channel information.

In step S2407, based on the channel information between the base station and the RIS, the base station determines a beamforming vector W_{RIS}. If the locations of the base station and the RIS are fixed, the channel information between the base station and the RIS may be pre-measured. In such a case, the base station may determine the beamforming vector W_{RIS} using the pre-measured channel information.

In step S2409, the base station transmits a reflection pattern to the RIS. The base station may directly transmit the reflection pattern, or may transmit a control signal requesting the initiation of passive beam sweeping. Upon receiving the reflection pattern, the RIS enhances the channel gain of UEs located in shadowed areas by controlling each of RIS's elements.

In step S2411, the base station transmits reference signals to the UEs with the beamforming vector W_{RIS} applied. The UEs that receive the reference signals measure channel gains.

In step S2413, the base station receives reflection channel information transmitted by the UEs. The reflection channel information may include reflection channel gain.

In step S2415, the base station integrates the received direct channel information and reflection channel information and selects UEs with higher channel gains as priority participants for AirComp. The base station may group UEs belonging to the direct channel group and reflection channel group separately with a limited number of members. Furthermore, since AirComp communication is performed for each group, one UE may belong to multiple groups. That is, a UE having both relatively high direct channel gain and reflection channel gain may be included in both the direct channel group and the reflection channel group. By selecting the channel with a higher channel gain, the base station may determine the order of UE participating in data aggregation during AirComp communication.

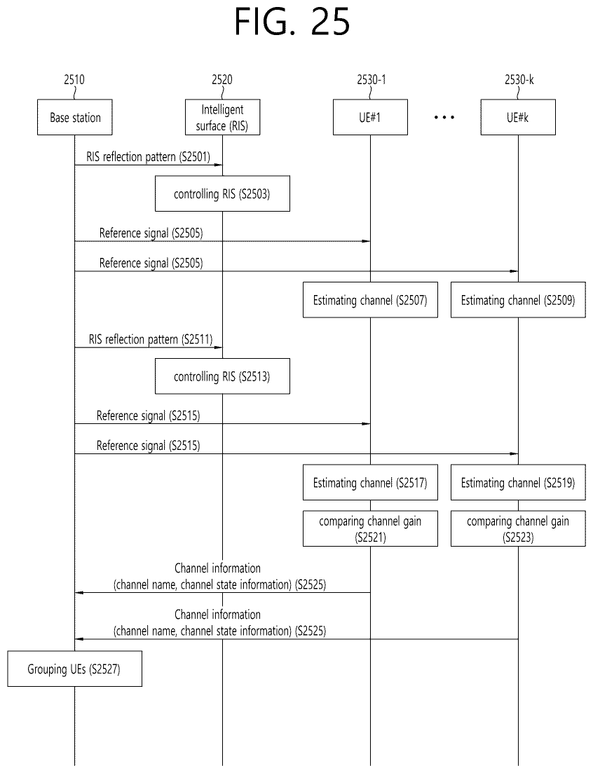

FIG. 25 is a diagram illustrating a signal flow among a base station 2510, UEs 2530-1 to 2530-k and an RIS 2520 when grouping is performed using the RIS according to an embodiment of the present disclosure. Referring to FIG. 25, the base station 2510 may perform grouping in such a manner that each UE 2530-1 to 2530-k transmits a channel having the largest channel gain based on channel information.

In steps S2501 and S2503, the base station 2510 transmits an RIS-off signal to the RIS 2520, and the RIS 2520 that has received the RIS_{off} signal stops its operation.

In step S2505, the base station 2510 transmits reference signal to each of the UEs 2530-1 to 2530-k in order to measure direct channel gain.

In steps S2507 and S2509, each of the UEs 2530-1 to 2530-k receives the reference signal and estimates the state of the direct channel by measuring direct channel gain.

In steps S2511 and S2513, the base station 2510 transmits a predetermined reflection pattern to the RIS 2520, and the RIS 2520 adjusts each of elements based on the received reflection pattern.

In step S2515, the base station 2510 transmits reference signal to which the predetermined reflection pattern has been applied.

In steps S2517 and S2519, each UE 2530-1 to 2530-k receives the reference signal and estimates the state of the reflection channel by measuring reflection channel gain.

In steps S2521 and S2523, each UE 2530-1 to 2530-k compares the direct channel gain and the reflection channel gain, and determines the channel having the greater channel gain as the channel to be used for AirComp communication. Since the reflection pattern of the RIS is not yet fully optimized, the measured direct channel and reflection channel gains may differ from those after optimization. The same phenomenon may occur when the base station 2510 measures the direct channel. Accordingly, the magnitudes of the direct channel gain and reflection channel gain may be compared in consideration of a compensation margin. The factors for determining the compensation margin may include at least one of the number of antennas of the base station 2510, the number of elements of the RIS 2520, the power of the reference signal for direct channel measurement or reflection channel measurement, the beam gain of beam sweeping during the control operation of the RIS 2520 or etc.

In step S2525, the base station 2510 receives channel information transmitted from the UEs 2530-1 to 2530-k. The channel information may include at least one of information related to a channel having the largest gain, a channel gain, a channel state or etc.

In step S2527, the base station 2510 may classify the UEs 2530-1 to 2530-k into a group that uses a direct channel and a group that uses a reflection channel by grouping a UEs having the same channel with largest channel gain.

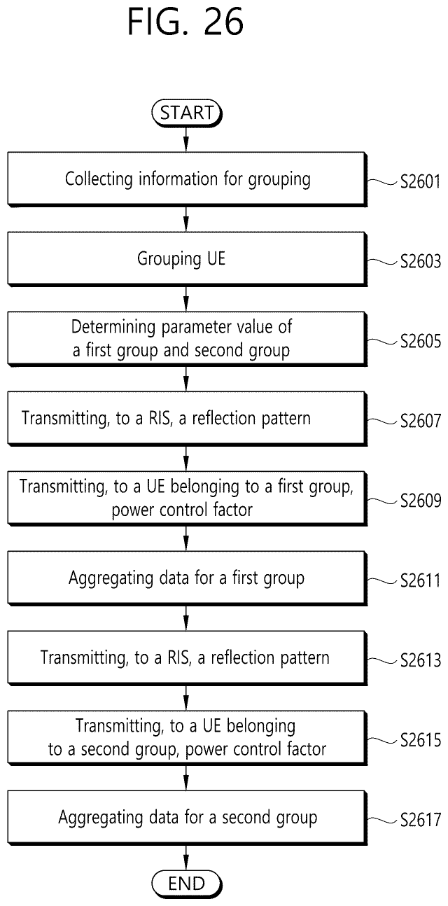

FIG. 26 is a diagram illustrating a method in which a base station performs AirComp communication through grouping for device selection according to an embodiment of the present disclosure. Referring to FIG. 26, the base station classifies UEs into a first group and a second group and then performs AirComp communication.

In steps S2601 and S2603, the base station collects information for grouping and performs grouping of UEs. The method by which the base station performs grouping is not limited to any specific method, and the base station may perform grouping by using the procedures illustrated in FIGS. 23 to 25. It is assumed that, through the grouping, the base station has classified the UEs into the first group and the second group.

In step S2605, the base station performs optimization of parameter values for the first group and the second group. The parameters to be optimized may include a decoding vector w and a reflection pattern φ. Since AirComp communication that simultaneously considers both a direct channel and a reflection channel requires that the decoding vector and the reflection pattern be determined according to [Equation 11], a large computational load may be required when an alternative approach is used. However, through grouping for device selection, the base station may perform optimization separately for each group by distinguishing between the direct channel and the reflection channel. The method by which the base station performs optimization may vary depending on which channel each group uses.

When optimizing a group that uses the direct channel, the base station may determine the decoding vector w without considering the reflection pattern of the RIS. The decoding vector w may be determined according to [Equation 14] below.

$${min}_{w} ( {max}_{k} \frac{{‖ w ‖}^{2}}{{‖ {w}^{H} {h}_{d , k} ‖}^{2}} ) \qquad [ Equation 14 ]$$

When optimizing a group that uses the reflection channel, the base station may determine the decoding vector w as a beamforming vector W_{RIS} according to channel reciprocity, and the reflection pattern φ may be determined according to [Equation 15] below.

$${min}_{Φ} ( {max}_{k} \frac{{‖ w ‖}^{2}}{{‖ {w}^{H} G Φ {h}_{r , k} ‖}^{2}} ) \qquad [ Equation 15 ]$$

By performing the optimization process separately using [Equation 14] and [Equation 15], the base station may reduce computations related to optimization while simultaneously improving the performance of the AirComp system. Based on the decoding vector w and the reflection pattern φ determined through [Equation 14] and [Equation 15], the base station may perform matrix lifting and may further perform optimization by using methods such as semidefinite relaxation (SDR), a difference-of-convex (DC) algorithm or etc. The base station may determine a power control factor η according to [Equation 13], based on the finally determined decoding vector w and reflection pattern φ.

In step S2607, the base station transmits to the RIS the reflection pattern determined for the first group in step S2605, thereby controlling the elements of the RIS. When the first group is a direct channel group, the base station may not transmit the reflection pattern to the RIS.

In step S2609, the base station transmits a power control factor to the UE belonging to the first group. The base station may transmit the power control factor to the UE by broadcasting. Each UE belonging to the first group may calculate a transmission coefficient corresponding to its channel condition according to [Equation 12]. When the power control factor is transmitted through broadcasting, each UE belonging to the second group may not calculate a transmission coefficient.

In step S2611, the base station receives signals with applied transmission coefficients from the UE belonging to the first group and aggregates the data.

In steps S2613 to S2619, the base station performs AirComp communication for the second group in the same manner as in steps S2607 to S2611.

Although the method disclosed in FIG. 26 illustrates an embodiment of dividing into the first group and the second group, the number of groups for which the base station performs grouping is not limited. For example, the base station may configure UEs to participate in AirComp into user groups based on the channel information received from the UE and may further perform grouping for user group according to channels. In another example, when a plurality of RISs are present, a list of UEs grouped by the base station may be classify into a direct channel group, a first reflection channel group and a second reflection channel group.

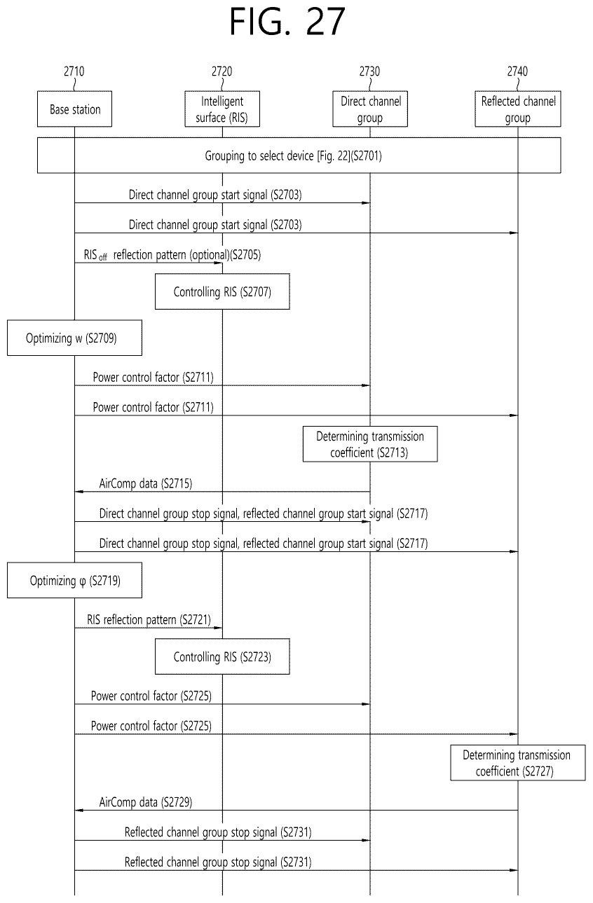

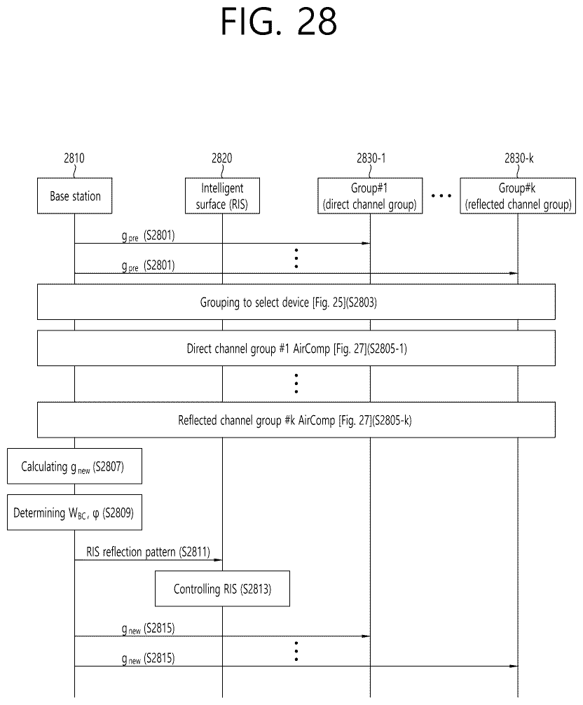

FIG. 27 is a diagram illustrating a signal flow between a base station 2710, an RIS 2720 and each UE group 2730 and 2740 in an environment for performing AirComp communication using an RIS, according to an embodiment of the present disclosure. Referring to FIG. 27, the base station 2710 may perform AirComp communication with a direct channel group 2730 and a reflected channel group 2740.

In step S2701, the base station 2710 performs grouping for device selection. The method by which the base station 2710 performs the grouping is not limited to any particular approach, and may include performing the procedures described with reference to FIGS. 23 to 25. The base station 2710 classifies UEs into a direct channel group 2730 and a reflected channel group 2740 by performing the grouping. The base station 2710 may transmit the grouping results to each UE.

In step S2703, the base station 2710 transmits a direct channel group start signal to the UEs belonging to the direct channel group 2730. The base station 2710 may transmit a start signal to UEs belonging to all groups 2730 and 2740 through broadcasting. When broadcasting is used by the base station, UEs that do not belong to the direct channel may ignore s signal related to an AirComp communication.

In steps S2705 and S2707, the base station 2710 may stop an operation of the RIS 2720 by transmitting an RIS_{off} signal to the RIS 2720. Since a signal gain using the RIS 2720 for UEs belonging to the direct channel group 2730 is small, the steps S2705 and S2707 may be omitted. Accordingly, the step S2705 is indicated as a dotted line in FIG. 27.

In steps S2709 and S2711, the base station 2710 optimizes the decoding vector w based on [Equation 14], and determines a power control factor η through [Equation 13] based on the optimized decoding vector w. The base station 2710 transmits the power control factor to the UEs belonging to the direct channel group 2730.

In step S2713, each UE belonging to the direct channel group 2730 determines a transmission coefficient. The transmission coefficient may be determined based on [Equation 12].

In step S2715, each UE belonging to the direct channel group 2730 transmits data to be used for AirComp based on the determined transmission coefficient, and the base station 2710 aggregates the data transmitted by each UE.

In step S2717, the base station 2710 transmits a direct channel group 2730 stop signal and a reflected channel group 2740 start signal to the UEs belonging to all groups 2730 and 2740. The base station 2710 may transmit stop signal and the start signal to the UEs belonging to all groups 2730 and 2740 through broadcasting. In a case where a method is used in which the UEs recognize that the AirComp operation of the direct channel group has ended upon receiving a reflected channel group start signal, the base station may omit transmission of the direct channel group 2730 stop signal.

In step S2719, the base station 2710 determines a reflection pattern φ for the reflected channel group 2740. The base station may determine a beamforming vector based on a pre-measured channel environment between the base station 2710 and the RIS 2720. The base station may configure the determined beamforming vector as a decoding vector, and perform optimization by determining the reflection pattern φ through [Equation 15].

In steps S2721 and S2723, the base station 2710 transmits the reflection pattern φ to the RIS 2720, and each of elements of the RIS 2720 are controlled based on the reflection pattern φ.

In step S2725, the base station 2710 determines a power control factor η through [Equation 13] based on the decoding vector w and the reflection pattern φ, and transmits the reflection pattern φ to the UE belonging to the reflected channel group 2740.

In step S2727, each UE belonging to the reflected channel group 2740 determines a transmission coefficient. The transmission coefficient may be determined based on [Equation 12].

In step S2729, each UE belonging to the reflected channel group 2740 transmits data to be used for AirComp communication based on the determined transmission coefficient, and the base station 2710 aggregates the data transmitted by each UE.

In step S2731, the base station 2710 transmits a reflected channel group 2740 stop signal to all UEs. The base station 2710 may transmit the termination signal to the UEs belonging to all groups 2730 and 2740 through broadcasting. When continuous AirComp communication is required, the operation may further include transmitting a new group start signal or a direct channel group 2730 start signal.

FIG. 28 is diagram illustrating a signal flow between a base station 2810, an RIS 2820 and k groups 2830-1 to 2830-k in a federated learning system environment utilizing AirComp communication using the RIS according to an embodiment of the present disclosure. Referring to FIG. 28, the base station 2810 may perform federated learning for each group 2830-1 to 2830-k and may determine a global model based on the models trained for each group 2830-1 to 2830-k. At least one group may exist, and multiple direct channel groups or multiple reflected channel groups may be present.

In step S2801, the base station 2810 transmits a previous global model gₚᵣₑ to all UEs. The base station may transmit the global model gₚᵣₑ to all UEs through broadcasting. After UE belonging to each group 2830-1 to 2830-k receives gₚᵣₑ, each UE performs local learning based on gₚᵣₑ.

In step S2803, the base station performs grouping for device selection to execute federated learning. The base station may perform the grouping according to the method disclosed in FIG. 25.

In steps S2805-1 to S2805-k, the base station performs AirComp for each group. The base station may perform AirComp for the direct channel group 2805-1 according to steps S2703 to S2717 disclosed in FIG. 27. The base station may perform AirComp for the reflected channel group 2805-k according to steps S2717 to S2731 disclosed in FIG. 27.

In step S2807, the base station determines a new global model g_{new}. The new global model g_{new} may be determined based on the local models trained by all UEs belonging to each group.

The base station may determine a global model gᵤ of the u-th group through [Equation 16] below.

$${g}_{u} = \frac{{\sum }_{i = 1}^{{M}_{u}} {z}_{i}}{{M}_{u}} \qquad [ Equation 16 ]$$

In [Equation 16], Mᵤ represents the number of UEs included in the u-th group, and zᵢ represents the local model trained by the i-th UE of the u-th group.

The base station may determine a new global model g_{new} through [Equation 17] below based on each group's global model gᵤ.

$${g}_{new} = \frac{{\sum }_{u = 1}^{{N}_{g}} {g}_{u}}{{N}_{g}} \qquad [ Equation 17 ]$$

In [Equation 17], N_{g} represents the total number of groups.

In steps S2809 to S2813, the base station determines a pre-defined transmission beamforming vector W_{BC} and a reflection pattern φ for broadcasting. The base station transmits the reflection pattern φ to the RIS, and the RIS controls each of elements based on the received reflection pattern φ.

In step S2815, the base station transmits the global model g_{new} to all groups 2830-1 to 2830-k, thereby completing a first round of federated learning.

After completing the first round, the base station may continue a second round of federated learning by repeating from the step S2805-1.

In FIG. 28, although it is illustrated under the assumption that downlink resources are sufficiently greater than uplink resources and that the base station transmits the global model to all groups through broadcasting to all devices, the base station may also transmit the global model to each group individually based on the grouping, which is also included in the embodiments of the present disclosure.

Examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on whether to apply the proposed methods (or information on the rules of the proposed methods) through a predefined signal (e.g., a physical layer signal or a higher layer signal).

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

### INDUSTRIAL AVAILABILITY

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method comprising:
transmitting, by a base station to a plurality of user equipment (UE)s, a first reference signal;
transmitting, by the base station, to the plurality of UEs, a second reference signal based on a channel between the base station and a reconfigurable intelligent surface (RIS);
receiving, by the base station, from the plurality of UEs, channel information based on the first reference signal and the second reference signal;
performing, by the base station, grouping into a plurality of groups based on the channel information;
transmitting, by the base station, to the plurality of UEs, a power control factor determined based on the channel information; and
receiving, by the base station, a signal in which a computation result of signals transmitted overlappingly over air by the plurality of UEs for each group is represented,
wherein the plurality of groups includes a first group using a first channel for direct communication between the base station and the plurality of UEs, and a second group using a second channel through the RIS.

2. The method of claim 1,
wherein transmitting, by the base station, to the plurality of UEs, the first reference signal, comprises:
transmitting, by the base station, to the RIS, a stop signal.

3. The method of claim 2,
wherein transmitting, by the base station, to the plurality of UEs, the second reference signal based on a channel between the base station and the RIS, comprises:
determining, by the base station, a beamforming coefficient and a reflection pattern of the RIS based on measured channel between the base station and the RIS;
transmitting, by the base station, to the RIS, the reflection pattern; and
transmitting, by the base station, to the plurality of UEs, the second reference signal based on the beamforming coefficient.

4. The method of claim 3,
wherein the channel information includes channel identification information having a largest channel gain and a channel gain value, and
wherein the grouping is performed with UEs for which the channel identification information having a largest channel gain is same.

5. The method of claim 4,
wherein the plurality of groups further includes a group in which UEs having the channel gain value not exceeding a threshold do not transmit signal to the base station.

6. The method of claim 4, further comprising:
adding, by the base station, a compensation margin to the channel gain based on at least one of a number of antennas of the base station, a number of elements of the RIS, a power of the first reference signal, a power of the second reference signal or a beam gain of the RIS beam sweeping.

7. The method of claim 1,
wherein transmitting, by the base station, to the plurality of UEs, the power control factor determined based on the channel information, comprises:
determining, by the base station, a beamforming vector of the second group based on measured channel environment between the base station and the RIS of the second group;
determining, by the base station, a decoding vector for the second group based on the beamforming vector of the second group;
optimizing, by the base station, a RIS reflection pattern for communication of the second group based on the decoding vector of the second group; and
determining, by the base station, a power control factor for the second group based on the decoding vector and the RIS reflection pattern which is optimized.

8. The method of claim 7,
wherein receiving, by the base station, the signal in which the computation result of signals transmitted overlappingly over air by the plurality of UEs for each group is represented, comprises:
transmitting, by the base station, to the plurality of UEs, a start signal of the first group;
receiving, by the base station, from a UE of the first group, a signal based on a control factor of the first group;
transmitting, by the base station, to the plurality of UEs, a start signal of the second group; and
receiving, by the base station, from a UE of the second group, a signal based on a power control factor of the second group.

9. The method of claim 1, further comprising:
transmitting, by the base station, to the plurality of UEs, a property value of a global model for federated learning; and
learning, by the base station, the global model based on the signal in which a computation result of signals transmitted overlappingly over air by the plurality of UEs for each group is represented.

10. The method of claim 9,
wherein learning, by the base station, the global model based on the signal in which a computation result of signals transmitted overlappingly over air by the plurality of UEs for each group is represented, comprises:
determining, by the base station, a local model for the each group based on the overlapping signals of the each group; and
learning, by the base station, the global model based on the local model of the each group.

11. A method comprising:
receiving, by a user equipment (UE), from a base station, a first reference signal;
receiving, by the UE, from the base station, a second reference signal based on a channel between the base station and a reconfigurable intelligent surface (RIS);
transmitting, by the UE, to the base station, channel information based on the first and second reference signals;
receiving, by the UE, a power control factor determined based on the channel information;
determining, by the UE, a transmission coefficient based on the power control factor; and
transmitting, by the UE, to the base station, a signal based on the transmission coefficient.

12. The method of claim 11,
wherein the channel information includes channel identification information having a largest channel gain and a channel gain value.

13. The method of claim 12, further comprising:
adding, by the UE, a compensation margin to the channel gain based on at least one of a number of antennas of the base station, a number of elements of the RIS, a power of the first reference signal, a power of the second reference signal or a beam gain of the RIS beam sweeping.

14. The method of claim 11,
wherein transmitting, by the UE, to the base station, a signal based on the transmission coefficient, comprises:
transmitting, by the UE, a signal based on the determined transmission coefficient in case where belongs the first group;
receiving, by the UE, a start signal of a second group; and
transmitting, by the UE, a signal based on the determined transmission coefficient in case where belongs the second group.

15. The method of claim 11, further comprising:
receiving, by the UE, from the base station, a global model for federated learning; and
learning, by the UE, the global model;
transmitting, by the UE, property value of learned global model.

16. A communication device comprising:
at least one processor; and
at least one memory connected to the at least one processor and storing instructions that, based on being executed, cause the communication device to perform operations
comprising:
transmitting, to a plurality of user equipment (UE)s, a first reference signal;
transmitting, to the plurality of UEs, a second reference signal based on a channel between the base station and a reconfigurable intelligent surface (RIS);
receiving, from the plurality of UEs, channel information based on the first reference signal and the second reference signal;
performing grouping into a plurality of groups based on the channel information;
transmitting, to the plurality of UEs, a power control factor determined based on the channel information; and
receiving a signal in which a computation result of signals transmitted overlappingly over air by the plurality of UEs for each group is represented,
wherein the plurality of groups includes a first group using a first channel for direct communication between the base station and the plurality of UEs, and a second group using a second channel through the RIS.

17.-18. (canceled)
